(19) United States
(12) Patent Application Publication
(10) Pub. No.: US 2013/0325508 A1
(43) Pub. Date: Dec. 5, 2013

(54) SYSTEMS AND METHODS FOR PROVIDING TRANSPARENT MEDICAL TREATMENT

(71) Applicant: COVIDIEN LP, MANSFIELD, MA (US)

(72) Inventors: KRISTIN D. JOHNSON, LOUISVILLE, CO (US); STEPHEN J. PACK, LOUISVILLE, CO (US); SCOTT F. ALEXANDER, WESTMINSTER, CO (US); DAVID BERLIN, NIWOT, CO (US); CHRISTOPHER T. RUSIN, GOLDEN, CO (US)

(21) Appl. No.: 13/905,943

(22) Filed: May 30, 2013

Related U.S. Application Data
(60) Provisional application No. 61/653,154, filed on May 30, 2012.

(51) Int. Cl. G06F 19/00

(52) U.S. Cl. CPC G06F 19/3418
USPC 705/3

(57) ABSTRACT

A system for tracking the location and activities of a patient is disclosed. The system includes: a patient location identification device associated with a patient; a patient data server including at least one server application executable on a computer, the patient data server remotely located from the patient location identification device wherein the patient data server and patient location identification device are configured to dynamically communicate with each other through the at least one server application; and a patient medical data file residing in at least one of the patient location identification device or the patient data server, the patient medical data file configured to maintain a plurality of recordable events generated by the patient location identification device.

### CROSS-REFERENCE TO RELATED APPLICATION

This application claims the benefit of and priority to U.S. Provisional Patent Application No. 61/653,154 filed on May 30, 2012, the entire contents of which are incorporated by reference herein.

### BACKGROUND

1. Technical Field

This disclosure relates generally to an apparatus, systems and methods for tracking the location and activities of patients in a medical facility and an apparatus, system and methods for an individual to maintain, organize and/or track patients' medical records and other related records.

2. Background of Related Art

In recent years, the medical industry has made major advancements in patient care. At least a portion of the cost of the advancements has been balanced by improving efficiency within, and between, organizations. At the same time, government mandates and new health care related laws are now requiring the medical industry to look for new areas to implement cost savings measures.

### SUMMARY

According to an embodiment of the present disclosure, a system for tracking the location and activities of a patient is disclosed. The system includes: a patient location identification device associated with a patient; a patient data server including at least one server application executable on a computer, the patient data server remotely located from the patient location identification device wherein the patient data server and patient location identification device are configured to dynamically communicate with each other through the at least one server application; and a patient medical data file residing in at least one of the patient location identification device or the patient data server, the patient medical data file configured to maintain a plurality of recordable events generated by the patient location identification device.

According to an aspect of the above embodiment, the patient location identification device includes a geo-location module configured to provide a geo-location of the patient and map data.

According to an aspect of the above embodiment, the patient location identification device is configured to provide navigational guidance to the patient based on the geo-location of the patient and the map data.

According to an aspect of the above embodiment, the patient location identification device is configured to generate an alert based on the geo-location of the patient, the map data and a patient status.

According to an aspect of the above embodiment, the patient location identification device is configured to generate a recordable event related to a change in the geo-location of the patient and the recordable event is stored as a geo-location record in the patient medical data file.

According to an aspect of the above embodiment, the patient location identification device is configured to generate a recordable event related to a medical examination by a clinician and the recordable event is stored as a medical examination record in the patient medical data file.

According to an aspect of the above embodiment, the patient location identification device is configured to generate an audio recording of the medical examination and the audio recording is stored as part of the medical examination record in the patient medical data file.

According to an aspect of the above embodiment, the patient location identification device is configured to generate a recordable event related to an electronic communication with a medical device and the recordable event is stored as a device record in the patient medical data file.

According to an aspect of the above embodiment, the medical device provides identification information corresponding to a clinician associated with the medical device and the patient location identification device generates a recordable event stored as a clinician record in the patient medical data file based on the identification information.

According to an aspect of the above embodiment, the medical device generates operational data related to the operation of the medical device and the operation data is stored in the device record in the patient medical data file.

According to an aspect of the above embodiment, the patient location identification device is configured to generate a recordable event related to a sensing of a radio frequency identification device (RFID) and the recordable event is stored as an RFID record in the patient medical data file.

According to an aspect of the above embodiment, the patient location identification device is configured to generate a recordable event related to medical data provided to the patient location identification device by a clinician and the recordable event is stored as a medical data record in the patient medical data file.

According to an aspect of the above embodiment, the patient location identification device is configured to generate a notification based on at least one record stored in the patient medical data file.

According to an aspect of the above embodiment, the notification is selected from the group consisting of a text message, a voice message, an email message, a page, a blog posting, a web page, and combinations thereof.

According to another embodiment of the present disclosure, a non-transitory computer-readable medium including software for monitoring patient location is provided. The software, when executed by a computer system, causes the computer system to perform operations including a method of: receiving information related to surrounding environment of a patient; categorizing the information; and generating and storing a medical record related to the information.

According to an aspect of the above embodiment, the receiving step further includes: receiving geo-location data related to a location of the patient; and determining whether the received geo-location data is medically related.

According to an aspect of the above embodiment, the receiving step further includes: receiving medical device identification information via a wireless communication network from a medical device; and receiving information and/or data related to the patient from the medical device.

According to an aspect of the above embodiment, the receiving step further includes: detecting an RFID associated with a single-use product; obtaining identification information from the RFID that uniquely identifies the single-use product; and determining a prior-use of the single-use product.

According to an aspect of the above embodiment, the receiving step further includes: receiving user-entered medical information pertaining to the patient; associating the received user-entered medical information with a clinician; and updating the medical record based on the received user-entered medical information.

According to an aspect of the above embodiment, the receiving step further includes: detecting a service requester device associated with a clinician; receiving identification information corresponding to the clinician from the service requester device; and updating the medical record based on the identification information corresponding to the clinician.

### BRIEF DESCRIPTION OF THE DRAWINGS

Various embodiments of the present disclosure are described herein below with reference to the figures wherein:

FIG. 1 illustrates a traditional health care network and the interconnections between various points of service within the traditional health care network;

FIG. 2 illustrates a health care network system utilizing a patient location identification device in accordance with embodiments of the present disclosure;

FIG. 3 illustrates a patient associated with a hospital patient location identification device and a hospital patient medical data file populated with records, information and data in accordance with embodiments of the present disclosure;

FIG. 4 illustrates the hospital patient medical data file of FIG. 3 and various reports generated therefrom in accordance with embodiments of the present disclosure;

FIG. 5 illustrates an individual associated with an individual patient location identification device and an individual patient medical data file populated with records, information and data in accordance with embodiments of the present disclosure;

FIG. 6 illustrates the individual patient medical data file of FIG. 5 and various reports generated therefrom in accordance with embodiments of the present disclosure;

FIG. 7 is an illustration of a surgical suite system utilizing a surgical kiosk in connection with a patient location identification device in accordance with embodiments of the present disclosure;

FIG. 8 is surgical timeline generated by the surgical kiosk and/or patent location identification device in accordance with embodiments of the present disclosure;

FIG. 9 is a report generation system for use with data obtained and generated from the system of FIG. 7 in accordance with embodiments of the present disclosure; and

FIG. 10 is a flow diagram illustrating the use of data generated from the systems, devices and methods for improving the efficiency of medical care in accordance with embodiments of the present disclosure.

### DETAILED DESCRIPTION

Particular embodiments of the present disclosure are described below with reference to the accompanying drawings; however, it is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to employ the present disclosure in virtually any appropriately detailed structure. In this description, as well as in the drawings, like-referenced numbers represent elements, which may perform the same, similar, or equivalent functions.

Additionally, the present disclosure may be described herein in terms of functional components, optional selections, and various processing steps. It should be appreciated that such functions may be realized by any number of hardware and/or software components configured to perform the specified functions. The present disclosure may employ various integrated circuit components including, but not limited to, memory elements, processing elements, logic elements, look-up tables, and combinations thereof, which may carry out a variety of functions under the control of one or more microprocessors or other control devices.

Similarly, the software elements of the present disclosure may be implemented with any programming or scripting language including, but not limited to, C, C++, C#, Java, COBOL, assembler, PERL, Python, PHP, and combinations thereof, with the various algorithms being implemented with any combination of data structures, objects, processes, routines or other programming elements. The object code created may be executed on a variety of operating systems including, but not limited to, Windows®, Macintosh OSX®, iOS®, linux, Android®, and combinations thereof.

Further, it should be noted that the present disclosure may employ any number of conventional techniques for data transmission, signaling, data processing, network control, and the like. It should be appreciated that the particular implementations shown and described herein are illustrative of the disclosure and its best mode and are not intended to otherwise limit the scope of the present disclosure in any way. Examples are presented herein which may include sample data items (e.g., names, dates, etc.) which are intended as examples and are not to be construed as limiting. Conventional data networking, application development, other functional aspects of the systems (and components of the individual operating components of the system) may be omitted for the sake of brevity. Further, the connecting lines shown in the various figures contained herein are intended to represent example functional relationships, physical and/or virtual couplings between the various elements. It should be noted that many alternative or additional functional relationships, physical, and/or virtual connections may be present in a practical electronic data communications system.

As will be appreciated by one of ordinary skill in the art, the present disclosure may be embodied as a method, a data processing system, a device for data processing, and/or a computer program product. Accordingly, the present disclosure may take the form of an entirely software embodiment, an entirely hardware embodiment, or an embodiment combining aspects of both software and hardware. Further, the present disclosure may take the form of a computer program product on a computer-readable storage medium having computer-readable program code means embodied in the storage medium. Any suitable computer-readable storage medium may be utilized, including hard disks, CD-ROM, DVD-ROM, optical storage devices, magnetic storage devices, semiconductor storage devices (e.g., USB thumb drives) and/or the like. Applications, as discussed herein, include computer program instructions that may be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified herein.

The present disclosure is described below with reference to block diagrams and methods, apparatus (e.g., systems), and computer programs according to various aspects of the disclosure. It will be understood that each function described and/or illustrated herein and combinations of functions can be implemented by computer program instructions. These computer program instructions may be loaded onto a general-purpose computer, special purpose computer, mobile device or other programmable data processing apparatus to produce a machine, such that the instructions that execute on the computer or other programmable data processing apparatus create means for implementing the functions specified and described herein.

The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, functions and block diagrams illustrated and described herein may be combined to form a means for performing the specified functions, combinations of steps for performing the specified functions, and program instruction means for performing the specified functions. It will also be understood that each function and combination of functions described herein, can be implemented by either special purpose hardware-based computer systems that perform the specified functions or steps, or suitable combinations of special purpose hardware and computer instructions.

One skilled in the art will also appreciate that, for security reasons, any databases, systems, or components of the present disclosure may consist of any combination of databases or components at a single location or at multiple locations, wherein each database or system includes any of various suitable security features, such as firewalls, access codes, encryption, de-encryption, compression, decompression, and/or the like.

The scope of the disclosure should be determined by the appended claims and their legal equivalents, rather than by the examples given herein. For example, the steps recited in any method claims may be executed in any order and are not limited to the order presented in the claims.

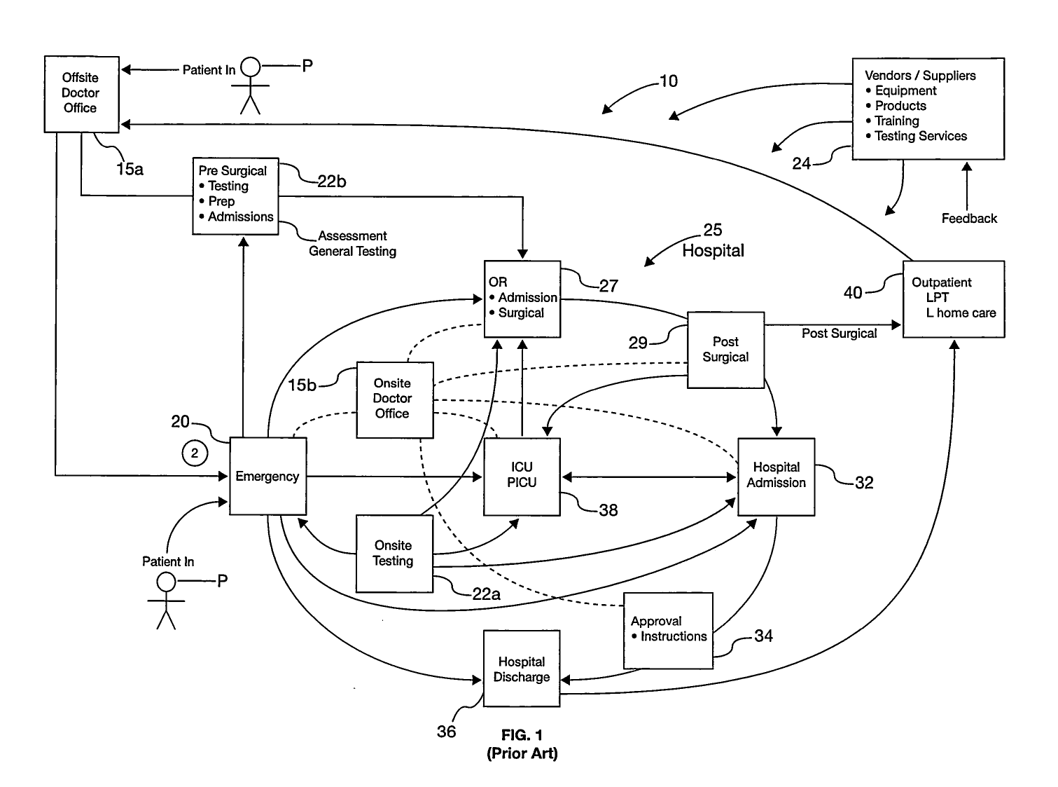

With reference to FIG. 1, a traditional health provider network model 10 is shown. In the traditional health provider model 10, patients P seeking medical treatment may enter the traditional health provider model 10 through one or more doctor's offices 15a, 15b or an emergency room 20. Doctor's office(s) 15a, 15b may be an offsite doctor's office 15a or an onsite doctor's office 15b located within a larger medical facility (e.g., hospital or medical complex). Doctor's office(s) 15a, 15b and emergency rooms 20 follow similar action steps with respect to patient care.

Generally, the steps in providing patient care include the steps of assessing the patient's P medical condition and determining a medical course of action. The step of assessing the medical condition of the patient P may include obtaining information related to the medical history of the patient P and obtaining a current medical condition of the patient P. Various tests may be performed to determine the current medical condition of the patient P. The past medical history of the patient P may be relevant to the current assessment. In particular, the results of test administered in the past may eliminate the need for new medical tests, may eliminate or suggest a possible course of action, may be used to select one medical course of action over another, may confirm a particular diagnosis and/or indicate new or additional tests that may be required. Additionally, one or more tests may be administered to ensure that a patient P is medically capable of receiving a particular medical course of action (e.g., patient P is sufficiently healthy to undertake a particular medical course of action). Without a complete and accurate medical history, new or additional tests may be directed to pursue a newly formed diagnosis and tests may be repeated or unnecessarily performed.

Medical records are generated and stored at various locations within the traditional health provider model 10. In embodiments, doctor's office(s) 15a, 15b may prescribe to the patient P a specific test such that the patient P is tested at a specialized testing a provider (e.g., onsite testing lab 22a, pre-surgical testing 22b or any other suitable testing facility). Similarly, a hospital 25 and/or emergency room 20 may also utilize onsite testing lab 22a and/or vendors 24 to perform testing (e.g., onsite MRI systems). As a result, medical records may be stored at multiple locations. In embodiments, results from a test performed by a testing lab 22a, 22b may be held by the facility that performed the test and copies of the tests results are then provided to one or more clinicians that analyze the results of the tests. Similarly, the analysis of the test by the clinicians may be typically maintained in their individual patient records and may then be distributed to other clinicians.

Medical records are generated throughout the traditional health provider model 10, as described below. Patient P enters the emergency room 20 and/or doctor's offices 15a, 15b seeking medical assistance. For simplicity, only an illustrative admission to the emergency room 20 is described herein. On admission to the emergency room 20, admission records related to patient P are created. During an initial examination in the emergency room 20, the examining nurse generates records related to the tests performed to obtain patient P's vital signs. The examining doctor may also create records related to symptoms of the current condition of the patient P. The doctor may order an X-ray and the radiology department generates an additional record including electronic X-ray images of patient P and a report analyzing the X-ray. After reviewing the X-ray and the report, the doctor orders an onsite testing lab 22a to perform an MRI. The onsite lab 22a generates a record including electronic MRI images of the patient P and a report analyzing the MRI. After reviewing the MRI and consulting with a supervisor, a surgical team is assembled and the patient P is then transferred to the operating room 27 where a pre-surgical team examines the patient P and reviews the records generated while the patient P was in the emergency room 20. This process of examination and record generation is repeated as the patient P travels through the medical facility (e.g., from emergency room 20 to operating room 27, to post-surgical 29 and/or the intensive care unit 30, etc.). The process of generating records, reviewing past records, is repeated when the patient P enters the hospital 25 through hospital admissions 32 until finally the patient P receives approval for discharge 34 and proceeds to hospital discharge 36.

Records related to patient P are generated throughout the traditional health provider model 10, including the offsite and onsite doctor's office(s) 15a, 15b, the hospital 25, the outpatient treatment center 40, and the like. Throughout the traditional health provider model 10, other records directly and/or indirectly related to the patient P are also generated. An example of a generated record that is directly related to the patient P includes billing records generated for each service, test and/or medication provided to the patient P. An example of records indirectly related to the patient P include internal control records that track when staff members (e.g., clinician) periodically check on a patient P, when a patient P is provided food, if and when the room assigned to the patient P is cleaned, and the like. In the traditional health provider model 10, records related to the patient P are stored by the entity generating the record. Many of the entries require human interaction and/or entry and are therefore susceptible to data entry error. Additionally, entries are rarely performed in real-time, therefore, entries typically lack any temporal information and/or accuracy. Further, the entries are rarely shared between various entities treating the patient P.

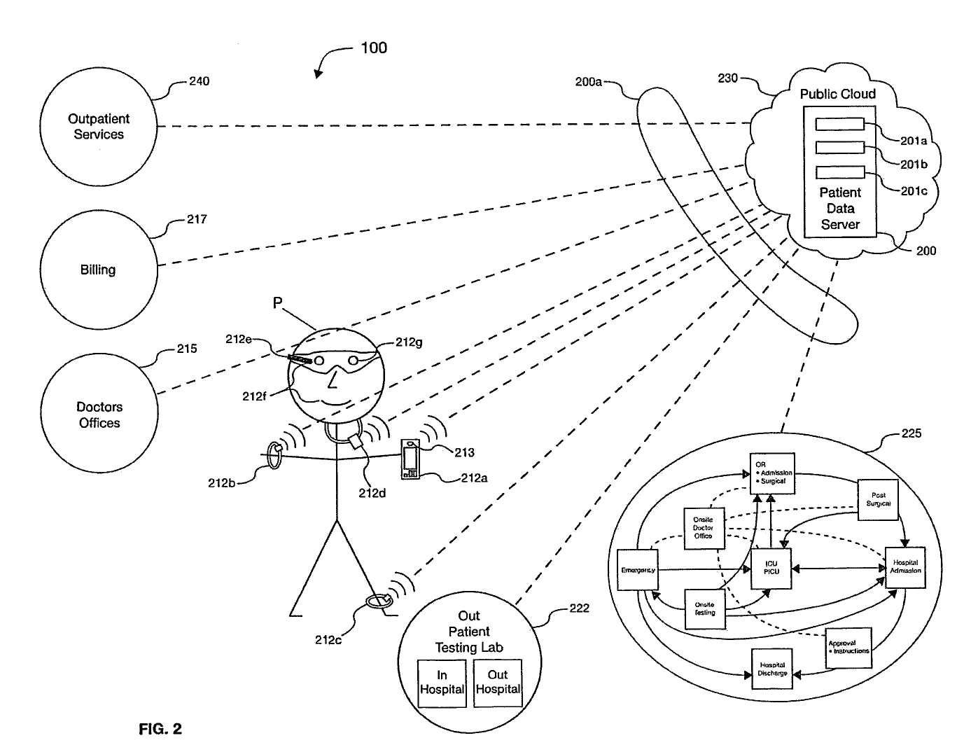

With reference to FIG. 2, a system 100 for tracking the location and activities of a patient in a medical facility is shown. The system 100 includes various embodiments of patient P location identification devices (hereinafter, “PLID”) 212a-212e for a personal user or for use within a clinical setting, are shown. PLID 212a-12d may be a handheld device (e.g., smartphone 212a, a tablet computer, personal computer, etc.) or a device worn by a patient P (e.g., an ankle band 212c, a wristband 212b, neckband 212d, optical eyewear 212e, etc. or any other suitable device that can be associated with a patient P.

PLID 212a-212e is configured to connect to a hospital patient data server 200, which includes one or more server application(s) 201a-201c. The server application(s) 201a-201c may be executed on a computer server remotely located from the PLID 212a-212e and/or remotely located from the hospital and facility. The hospital patient data server 200 and PLID are configured to dynamically connect to each other through one or more server application(s) 201a-201c.

Hospital patient data server 200 may reside in any suitable server (e.g., computer) illustrated generally as a non-descript public cloud-computing service 230 (hereinafter “the cloud 230”). In embodiments, the cloud 230 provides a service that executes the service communication network server application(s) 201a-201c rather than providing a dedicated identifiable server (e.g., hardware) to execute the server application(s) 201a-201c. In further embodiments, one or more dedicated servers, or a fractional portion of their computing capability, may be utilized to execute the server application(s) 201a-201c and to provide functionality described herein. Hospital patient data server 200 may also reside in the facility maintaining the records related to patient P records. In embodiments, the hospital may have a server, or any dedicated portion of a server assigned to the execution and maintenance of data provided by the systems, methods and apparatuses described herein

PLID 212a-212e is configured to connect to the hospital patient data server 200 through any suitable communication network (e.g., WiFi, WWW, Telnet, LAN, MAN or any other suitable communication network). PLID 212a-212e may also interface and/or interconnect with, or through, a personal computer or a wireless device capable of providing the flexibility and functionality of a mobile communications device and the processing and networking capability of the personal computer.

As used herein, the PLID 212a-212e refers to a multifunctional device. The PLID 212a-212e may include a user interface or may connect to a user interface through a communication device as described herein. The PLID 212a-212e, in addition to the functionality described herein, may also include hardware supported by a variety of applications including, but not limited to, telephone applications, video conferencing applications, e-mail applications, instant messaging applications, digital camera applications, digital video camera applications, web browsing applications, digital music player applications, digital video player applications, communication application, and combinations thereof.

PLID 212a-212e may also include two or more components that work in conjunction with each other to provide the functionality of a single portable communication device. In embodiments, the PLID 212a-212e may be a multifunctional communication device, which includes separate body-attachable components such as a first component that captures and/or displays video and a second component including a processing unit that communicates with the other components via a wired and/or wireless communication network.

The PLID 212a-212e may also include one or more applications that may be executed by the multifunctional device and may use at least one common physical user-interface device, such as a monitor, user interface terminal, and/or a touch screen.

PLID 212a-212e may further include any of the following modules, which include, but are not limited to, a telephone module, a video conferencing module, an e-mail client module, an instant messaging (IM) module, a camera module for still and/or video images, an image management module, a video player and/or recorder module, an audio player and/or recorder module, a browser module, and combinations thereof. Modules may be configured to interface with one or more hardware components of the PLID 212a-212e.

The PLID 212a-212e may include RF (radio frequency) circuitry that is configured to receive and transmit RF signals. The RF circuitry converts electrical signals to/from electromagnetic signals and communicates with communications networks and other communications devices via the electromagnetic signals. The RF circuitry may include well-known circuitry for performing these functions, including but not limited to, an antenna system, an RF transceiver, one or more amplifiers, a tuner, one or more oscillators, a digital signal processor, a CODEC chipset, a subscriber identity module (SIM) card, memory, and combinations thereof. The RF circuitry may communicate with networks, such as the Internet, also referred to as the World Wide Web (hereinafter, “WWW”), an intranet and/or a wireless network, such as a cellular telephone network (Telnet), a wireless local area network (LAN) and/or a metropolitan area network (MAN), and other devices and/or networks that utilize wireless communication. The term “wireless communication” as used herein includes any of a plurality of communications standards, protocols and technologies, including but not limited to, Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS), and/or Short Message Service (SMS)), or any other suitable communication protocol, including communication protocols not yet developed as of the filing date of this disclosure, and combinations thereof.

The PLID 212a-212e may include audio circuitry, a speaker, and a microphone that provides audio interface between a user and the PLID 212a-212e device. The audio circuitry receives audio data, converts the audio data to an electrical signal, and transmits the electrical signal to the speaker. The speaker converts the electrical signal to human-audible sound waves. The audio circuitry also receives electrical signals converted by the microphone from sound waves. The audio circuitry converts the electrical signal to audio data and transmits the audio data for processing. Audio data may be retrieved from and/or transmitted to memory and/or the RF circuitry by the peripherals interface. Audio circuitry may include a headset jack that provides an interface between the audio circuitry and removable audio input/output peripherals, such as output-only headphones or a headset with both output (e.g., a headphone for one or both ears) and input (e.g., a microphone).

The PLID 212a-212e may include input/output peripherals such as a touchscreen, a head-mounted display, a voice command module, or other input control devices such as physical buttons (e.g., push buttons or rocker buttons), touchpad, dials, slider switches, joysticks, click wheels, and the like. The PLID 212a-212e may be configured to optionally connect to peripheral devices such as a keyboard (e.g., QWERTY), an infrared port, a USB port, a pointer device (e.g., a mouse), etc. The one or more buttons may include an up/down button for volume control of the speaker and/or the microphone. The one or more buttons may include a push button configured to disengage or lock the touch screen. The touchscreen, touchpad or other input control device may be used to implement virtual or soft buttons and one or more soft keyboards.

The touch-sensitive area and the associated screen (e.g., touchscreen), if present, provides an input interface and an output interface between the PLID 212a-212e and a user. Alternatively, the PLID 212a-212e receives and/or sends electrical signals from/to a display and/or touchscreen that provide visual output to the user. The visual output may include graphics, text, icons, video, and any combination thereof (collectively termed “graphics”). In a hospital setting, the PLID 212a-212e may utilize a television proximate the patient P as a display to provide visual outputs to the user.

In embodiments, the PLID 212a-212e includes hardware components and software stored in memory configured to interface with the hardware components. One hardware component may include a global positioning system (GPS) or any other geo-location module (e.g., using WiFi signals) that determines the location of the PLID 212a-212e. PLID 212a-212e provides geo-positional information for use by or in various hardware components, software applications and in the generation of event data and/or medical record data as described herein. The GPS module may be utilized to identify when patient P is proximate a location identified by the patient P, as described below.

In conjunction with an imaging module, one or more optical sensors may be used to capture still images or video. In embodiments, an optical sensor may be located on the back of the PLID 212a-212e, opposite the display (if present) on the front of the PLID 212a-212e, so that the display may be used as a viewfinder for either still and/or video image acquisition. In further embodiments, an optical sensor may be located on the front of the PLID 212a-212e so that the user's image (e.g., facial image, retinal image or any other identifiable body portion) may be obtained for identification. An optical sensor located on another portion of the PLID 212a-212e may also be used to identify or document the identification of a medical service provider. In additional embodiments, the position of the optical sensor can be changed by the user (e.g., by rotating the lens and the sensor in the PLID 212a-212e housing or by repositioning and/or refocusing the sensor by adjusting the position of the body) so that a single optical sensor may be used along with the display for still and/or video image acquisition.

The PLID 212a-212e generally provides an improved system, method and apparatus for obtaining, controlling, managing and utilizing medical data and information related to medical care. As can be appreciated, PLID 212a-212e includes the capability to obtain information, data and documentation (e.g., pictures, geo-positional data, clinician identification) related to medical services provided to the patient P. Additionally, PLID 212a-212e includes the capability to process and communicate the information, data and documentation obtained to the hospital patient data server 200 to generate and/or populate a patient medical data file (hereinafter “PMDF”).

In the medical context, medical providers utilizing a PLID 212a-212e, may improve the efficiency and quality of medical services while streamlining and improving the efficiency of their medical practices. In a personal context, a PLID 212a-212e provides a means for a patient P to obtain, control and manage all aspects of their medical records, medical data, medical information, and information related to the health and well-being of the patient P. Additionally, an individual PLID 212a-212e generates independent records related to the health and well-being of the patient P. The PLID 212a-212e also provides the ability to compare, combine and analyze data obtained from different records (e.g., records obtained from various medical treatment facilities in addition to internally generated records).

A PLID 212a-212e is associated with patient P thereby providing the ability to seamlessly track and communicate with patient P, associate patient P with various activities and/or products, associate patient P with individuals within a medical setting and/or associate patient P with financial aspects of the medical setting.

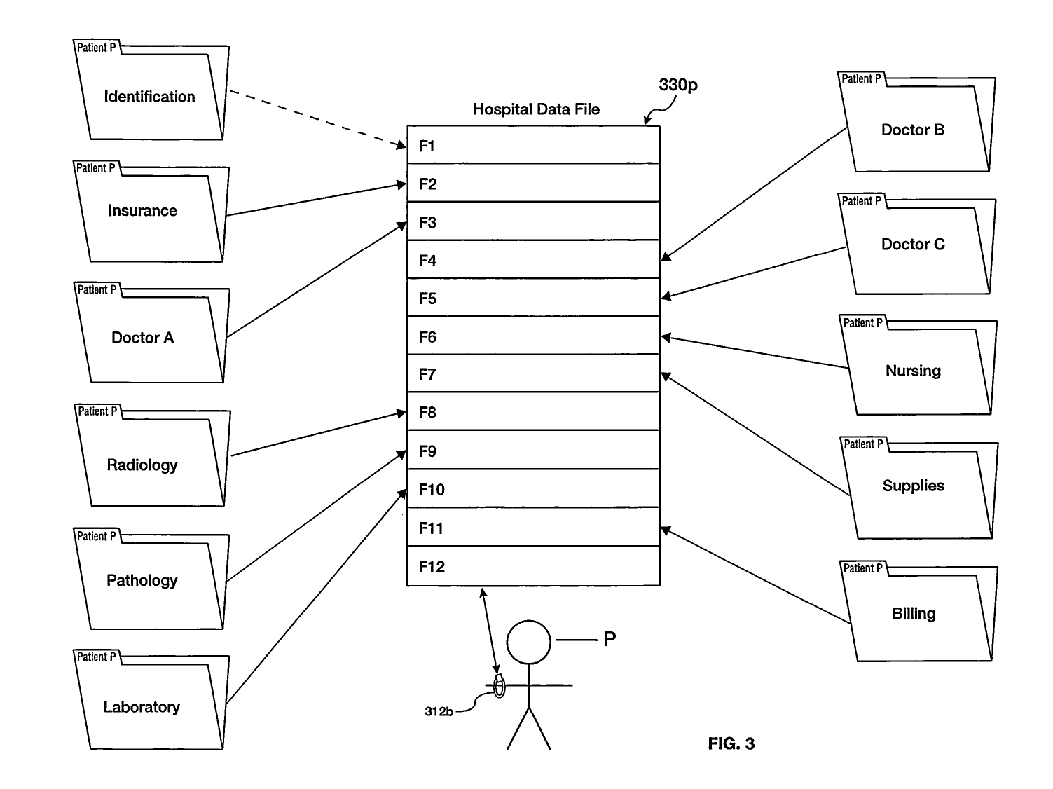

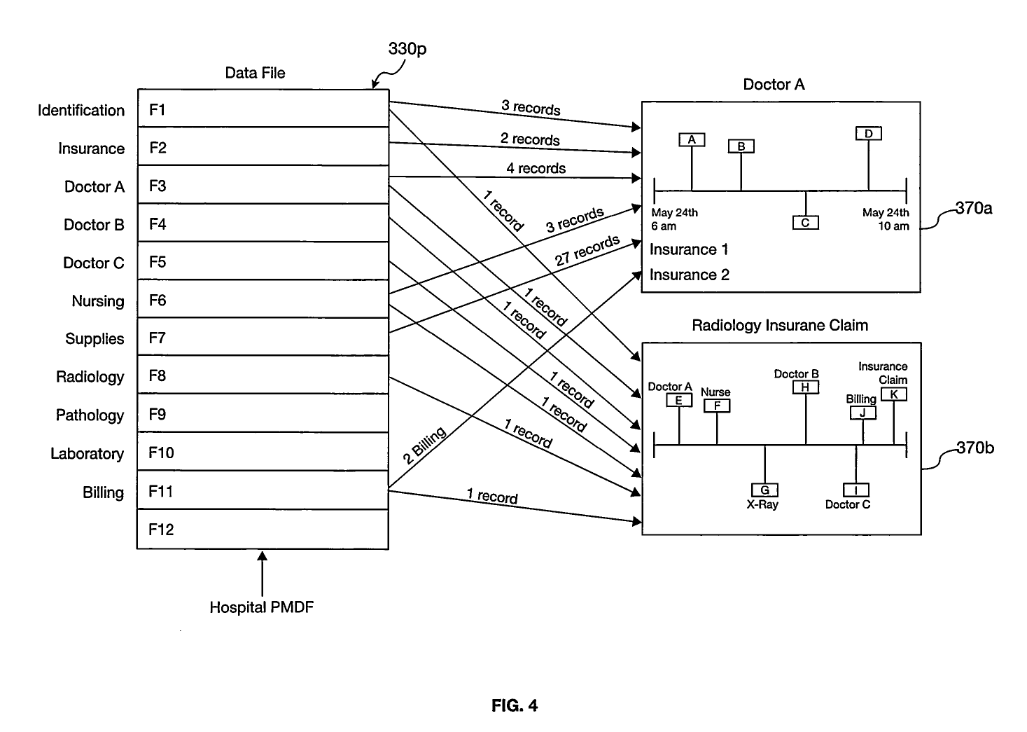

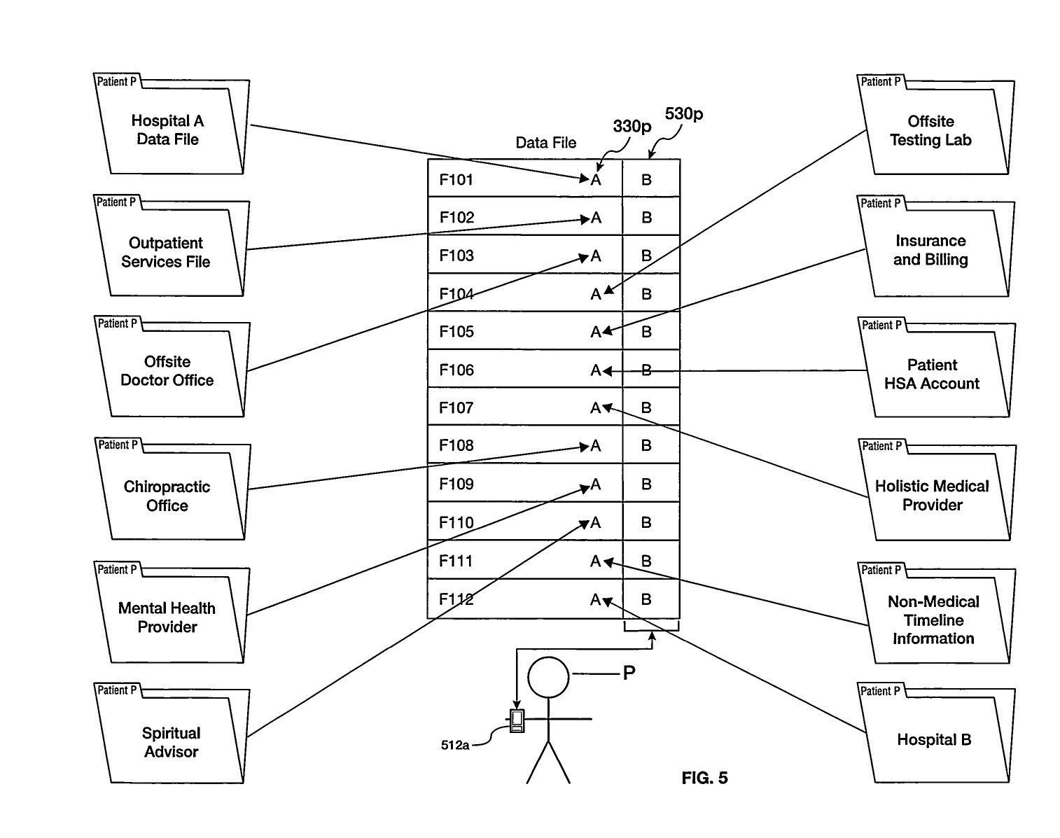

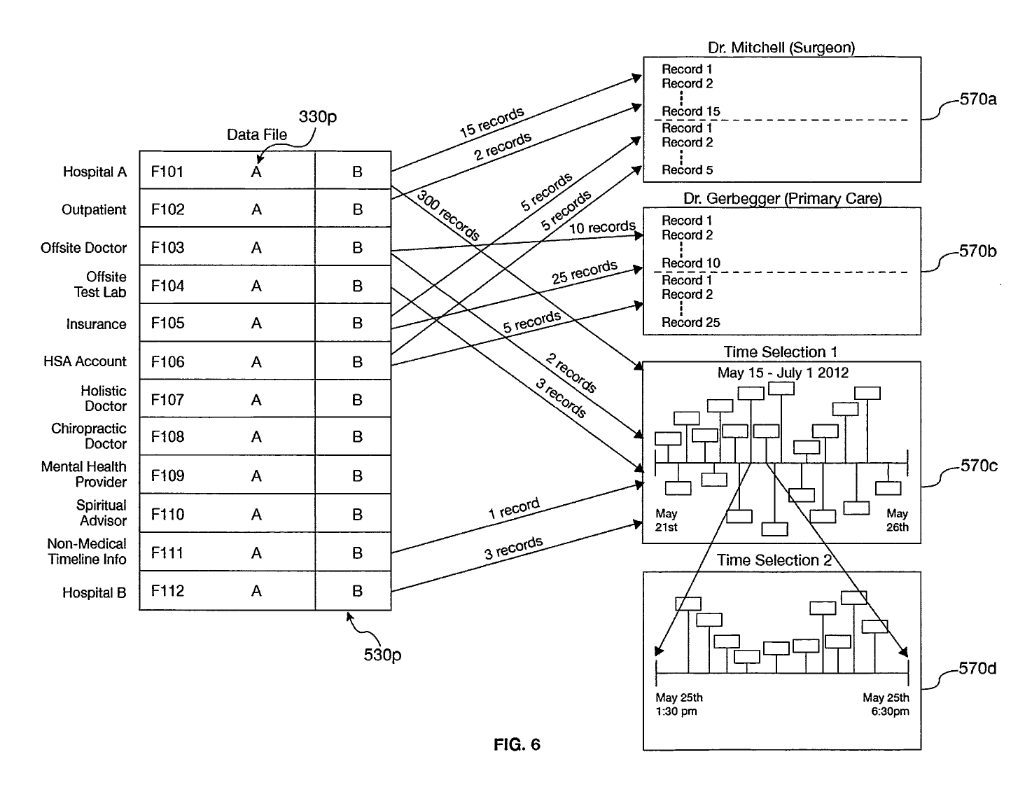

In use, the PLID 212a-212e identifies recordable events and stores the recordable events in a PMDF as described below with respect to a hospital PMDF 330p as shown in FIGS. 3-4 and an individual PMDF 530p as shown in FIGS. 5-6. A recordable event may be one or more medical events, medically related events, or general events related to the well-being of the patient. Medical events include receiving a medical related treatment (e.g., imaging, medication, fluids, etc.), consulting with a clinician, undergoing a procedure, and the like. Recordable events include non-medical events related to medical events including, but not limited to, the patient P being relocated to a particular department in the facility (e.g., relocated to a surgical suite or radiology department). Events related to the well-being of the patient include events that may result in a change in medical condition, such as changing employment or relocating to a new city.

Recordable events may also include any event related to the surrounding environment of the patient. Aspects of the surrounding environment may be automatically detected, triggered by a change in a condition and/or manually created by the patient and/or a clinician. The recordable event may be directly provided to, and/or written in, the PMDF 330p, 530p by the PLID 212a-212e. PLID 212a-212e may also provide a record of a recordable event to the hospital patient data server 200 and the patient data server may provide the record to the PMDF 330p, 530p.

PLID 212a-212b also includes the capability to communicate and/or sense the presence of any identification device and/or information generating component. In embodiments, a wireless communication module on the PLID 212a-212b may be configured to identify other devices in the proximity of the PLID 212a-212e utilizing wireless communication. PLID 212a-212b may further identify additional characteristic of the device such as the name of the device, the name of the network on which the device communicates, or identification may be obtained by pinging the device. The device, and/or the user of the device, may be determined by interfacing with a medical communication network wherein devices are assigned to medical personnel, as described in a commonly-owned U.S. patent application Ser. No. 13/768,457, the entire contents of which are incorporated by reference herein.

PLID 212a-212e may also communicate and/or identify equipment utilizing wireless communications. In embodiments, the PLID 212a-212e may identify a computer that connects to a server over a wireless communication network. Equipment may also include medical and/or medical equipment such as an electrosurgical generator, a patient health monitor, an imaging system (e.g., X-ray, MRI, ultrasound, CT-scan, etc.), a metering system (e.g., intravenous drip, medication meters, etc.), and the like. Equipment may also include personal effects such as, for example, a smart phone, tablet, computer or any other electronic devices.

PLID 212a-212e may obtain operational information and/or data related to the equipment or related to the operation of the equipment. In embodiments, PLID 212a-212e may communicate with a medical device (e.g., an X-ray imaging machine) and the medical device may provide the PLID 212a-212e with the operational parameters (e.g., the number of images taken by the X-ray machine, the time-date stamp for each image, etc.). Additionally, the medical device may provide the PLID 212a-212e with an electronic copy of diagnostic data (e.g., images obtained by the X-ray imaging machine).

The PLID 212a-212e may also generate an equipment record that identifies the medical device and provides the information and/or data obtained therefrom. Medical device or equipment records are provided to, and stored in, the PMDF 330p, 530p as shown in FIGS. 3-6 and described in further detail below. Medical devices may be identified by capturing an image of the device with the PLID 212a-212e and comparing the captured image with images stored in a library and/or database of device images.

Records stored in the PMDF 330p, 530p may be classified in accordance with a corresponding event that triggered the creation of the record. Creation and storage of a geo-positional record may be triggered by the relocation of a patient within a medical facility or an individual entering an address designated as a medical-related facility (e.g., outpatient service location, off-site doctor's office(s), pharmacy, health care facility, etc.) as determined by the GPS module in the PLID 212a-212e. Creation and storage of a medical examination record and/or a clinician record may be triggered by the patient being in close proximity with a clinician as determined by the communication of the PLID 212a-212e with a similar clinician identification device as discussed below (e.g., a service requester device). Creation and storage of a medical data record may be triggered by a clinician providing medical data to the PLID 212a-212e or a system associated with or in communication with the PLID 212a-212e. Creation and storage of a medical device or equipment record may also be triggered by the PLID 212a-212e electronically identifying equipment proximate the patient and/or the PLID 212a-212e receiving records, information and/or data from equipment (e.g., X-ray machine providing electronically transmitted images).

With continued reference to FIG. 2, the PLID 212a-212e may also communicate through a PLID network 200a with other systems and devices configured to communicate through the PLID network 200a. The PLID network 200a may provide a connection between a PLID 212a-212e and other systems on the PLID network 200a. In embodiments, PLID network 200a may provide the PLID 212a-212e with a direct connection to record generating components of a hospital 225. The PLID network 200a may provide a direct connection between the PLID 212a-212e and other medical service providers such as, outpatient services 240, billing services 217 (e.g., hospital billing and/or insurance companies), doctor's office(s) 215, outpatient testing labs 222, and/or any other information selected by the patient P. The PLID network 200 may also function as a peer-to-peer system (e.g., without a special purpose server executing the server application 201a-201c) wherein the functionality of the server application(s) 201a-201c described herein is incorporated into each PLID 212a-212e.

The PLID network 200a may also provide an indirect connection to other components on the PLID network 200a. The hospital patient data server 200 may include a server application(s) 201a-201c that facilitates connections between devices connected to the PLID network 200a. The server application(s) 201a-201c may be configured to receive a request for information and/or data from a PLID 212a-212e or from another device connected to the PLID network 200a.

The PLID 212a-212e may be used in a medical setting (e.g., hospital) as a hospital PLID 312b and/or in an individual/personal capacity as an individual PLID 512a. As illustrated in FIG. 3, the hospital PLID 312b, which is substantially similar to the PLID 212a-212e, is assigned to a patient P upon entering a hospital or other medical treatment site. In this particular setting (e.g., hospital, clinic and/or doctor's office(s)), the hospital PLID 312b is temporarily associated with patient P thereby providing the ability to temporarily track and communicate with patient P.

As illustrated in FIG. 5, the individual PLID 512a is associated with patient P, and is connected with the individual PMDF 530p associated with the patient P. The individual PLID 512a and individual PMDF 530p enable the patient P to access and/or control his/her medical records, medical related information and medical related data. Additionally, an individual PLID 512a obtains and tracks records, information and data that may not contain medical information but may be related to the medical records, as discussed below.

The hospital PLID 312b and the individual PLID 512a both identify actions and conditions related to the health, care and well-being of a patient P. The hospital PLID 312b and/or the individual PLID 512a may be used individually, interchangeably, or in conjunction with each other.

The patient P may carry the individual PLID 512b at all times to continuously monitor personal medical events (e.g., doctor visits, exercising, physical exertion, etc,). The hospital PLID 312b is utilized to track medical activities of the patient P within the medical treatment setting.

With respect to the hospital PLID 312b, upon entering the medical setting, the identification of the patient P is determined and the hospital PLID 312b is assigned to the patient P and attached to the wrist of the patient P. Identification may be determined by traditional means, such as, for example, making inquires and verifications as to name, date of birth and/or social security number. After the patient P is identified, the hospital PLID 312b determines if the patient P has an existing hospital PMDF 330p. If an existing hospital PMDF 330p is identified, the hospital PLID 312b is associated with the hospital PMDF 330p and any information, data and/or records obtained by the hospital PLID 312b are provided to the hospital PMDF 330p. In situations when the traditional model of identification fails, such as when the required information cannot be readily obtained (e.g., patient P is unable, unwilling or otherwise incapable of providing information due to age and/or condition), the hospital PLID 312b may be utilized to identify the patient P by utilizing a module on the PLID 312. In embodiments, as shown in FIG. 2, a camera module 213 on the hospital PLID 312b may obtain an image of the retina 212g, an image of the face 212f, or any suitable body component that may be used in a biometric identification system to positively identify patient P. The biometric identification is obtained by the hospital PLID 312b and compared with biometric identification information stored in the hospital PMDF 330p to find a match thereby providing identification of the patient P.

Hospital PLID 312b may further display identification information currently provided on plastic identification bands to facilitate the gradual migration from a legacy system utilizing plastic identification bands to a system that only utilizes hospital PLID 312b and hospital PMDF 330p.

Geo-location functionality of the PLID 312b may also be used to ensure that optimal care is being provided to the patient P and/or best practices are followed. As the patient P enters the treatment facility with a known condition (e.g., suspected stroke) for which he needs to receive treatment or diagnostic testing (e.g., CT scan) within a predetermined time period, the hospital PLID 312b may alert the clinician or other personnel if such treatment was not provided to the patient P within the set time period. The hospital PLID 312b may also be used to locate the patient in need of medical treatment who has moved outside of the treatment area (e.g., emergency room) to ensure that the patient P is treated in a timely manner. The individual PLID 512a may also be used to tie the geo-location of the patient P to a known location of clinics, doctor's office, and other medical care provides to ensure that timely medical treatment is provided to the patient P. This geo-location functionality of the hospital PLID 312b and/or the individual PLID 512a improves patient outcome by ensuring that specific medical protocols are followed.

The hospital PLID 312b may also be used a guidance tool to provide navigation instructions and/or directions to the patient P during the stay at the hospital. The hospital PLID 312b may access the healthcare facility mapping data and may use the mapping data in conjunction with its geo-position to guide the patient P. In particular, the hospital PLID 312b may alert the patient P to the current location and provide audio and/or visual guidance (e.g., arrows, directions, etc.) to guide the patient to the appropriate location to receive care. The navigation may commence automatically in response to a scheduled procedure and/or manually.

As discussed above, each PLID 212a-212e obtains information and/or data to generate records that populate the hospital PMDF 330p in as shown in FIGS. 3-4 and the individual PMDF 530p as shown in FIGS. 5-6 and described in further detail below. The hospital PMDF 330p and individual PMDF 530p may reside as an electronic file in any suitable electronic storage device (e.g., stored in the PLID 212a-212e, hospital patient data server 200, dedicated portion of a hospital server, etc.).

FIGS. 3-6 illustrate the hospital PMDF 330p and the individual PMDF 530p, respectively. FIGS. 4 and 6 illustrate reports based on extracted records, data and information from the respective hospital PMDF 330p and individual PMDF 530p, respectively. Reports may be configured to extract information from records contained in one or more files F1-F12 and F101-F112 contained in the respective PMDF 330p, 530p. Reports are provided as examples of information that may be extracted and should not be construed as limiting.

Hospital PMDF 330p, while generated by a hospital for use in the hospital, is a patient record and is therefore incorporated as a record into the individual PMDF 530p as the Hospital A file F 101, data file A. As such, Hospital A file F 101 includes data file A which is identical to the hospital patient records and data file B which includes records related to Hospital A and generated by the individual PMDF 530p.

Access to the hospital PMDF 330p may require proper authorization and/or notification, as required by local, state and federal laws and regulations, before providing access to medical records. As such, hospital PMDF 330p maintains compliance with said laws and regulations. Hospital PMDF 330p may also prevent inadvertent or accidental release of medical records by requiring proper identification and documentation to access the hospital PMDF 330p.

With reference to FIGS. 3 and 4, the hospital PMDF 330p is generated by the hospital for use in the hospital setting. The hospital PMDF 330p includes a plurality of file entries that include information and data related to patient P. Hospital PMDF 330p may also include data and information related to identification F1, insurance F2, doctor A F3, doctor B F4, doctor C F5, nursing F6, supplies F7, radiology F8, pathology F9, laboratory F10 and billing F11. The various files F1-F12, structure and arrangement of the information and data contained in the PMDF 330p is provided as an illustrative example and should not be construed as limiting. Data and information provided and entered into the hospital PMDF 330p may be arranged and organized in any suitable manner.

With reference to FIGS. 5 and 6, the individual PMDF 530p is generated by patient P to maintain records related to the health and well-being of the patient P. Individual PMDF 530p includes a plurality of files F101-F112 that include data and information from various medical-related sources. More specifically, individual PMDF 530p may include files related to hospital A F101, outpatient services F102, offsite doctor's office F103, offsite test lab F104, insurance F105, health savings account F106 (hereinafter “HSA”), holistic doctor F107, chiropractic office F108, mental health provider F109, spiritual advisor F110, non-medical timeline information F111 and hospital B F12. Unlike the hospital PMDF 330p that only included information and data related to and/or provided to the hospital that created the hospital PMDF 330p, the individual PMDF 530p includes records from any sources selected by the patient P.

The individual PMDF 530p enables patient P to maintain records related to the health and well-being outside of the clinical setting. Patient P may review upcoming scheduled surgical procedure information before arriving at the hospital or procedural setting. Since individual PLID 512a and associated individual PMDF 530p is periodically updated with information from the hospital PMDF 330p, patient P may check scheduling to ensure that the procedure is scheduled.

Patient P, utilizing the individual PLID 512a, may also access the individual PMDF 530p and review the status of tests (e.g., lab results). Patient P may also utilize the individual PLID 512a to access the individual PMDF 530p to check the status of prescriptions placed by the clinician, confirm that a test has been ordered, verify that a test has been read, and/or confirm that a test has been performed. Patient P may also review records, information, data and recordings related to the patient P as discussed above.

Patient P may also generate reports from records, and information and data contained in the files of the individual PMDF 530p. With reference to FIG. 6, exemplary reports are illustrated, such as Dr. Mitchell Report 570a and Dr. Gerbegger Report 570b, which include records, information and data related to services from Dr. Mitchell and Dr. Gerbegger, respectively. The Dr. Mitchell Report 570a includes fifteen (15) entries from the Hospital A file F1, two (2) records from Outpatient F2, five (5) records from the Insurance file F5 and five (5) records from the HSA Account file F6. Patient P may review the content of each record by selecting each entry in the report and reviewing the record, information, and data contained therein. The Dr. Gerbegger Report 570b includes ten (10) entries from the Offsite Doctor file F3, twenty-five (25) records from the Insurance file F5, and five (5) entries from the HAS Account file F6.

Each file in the individual PMDF 530p includes Sections A and B, wherein Section A is an exact copy of the medical record obtained from each source and Section B hospital includes entries generated by the PLID 212a-212e (FIG. 2) of the patient P, namely a PLID 312B (FIG. 3), an individual PLID 512a (FIG. 5), respectively. Section A may also be periodically updated by replicating the hospital PMDF 330p into Section A of Hospital A file F101. Section A may also be recreated from records obtained from a release of records submitted to Hospital A. In embodiments, section A may also be dynamically linked to the hospital PMDF 330p. In further embodiments, hospital PMDF 330p and Section A of the individual PMDF 530p may be linked to the same record, wherein the same record resides on a server available for use by the hospital and patient P (e.g., individual PMDF 530p resides on the patient data server 200 in the cloud 230).

Section B of the individual PMDF 530p includes records that include data and/or information related to the records in Section A and obtained by the individual PLID 512a, which is substantially similar to the PLID 212a-212e. In embodiments, Hospital A, Section A may include a record indicating when specific treatment was performed (e.g., an X-ray was taken of patient P) and a record providing information related to the procedure. Hospital A, Section B may include a geo-location record indicating where the treatment took place (e.g., that patient P was transported to radiology at 9:43 am), an equipment record indicating the medical device that was used to perform the procedure (e.g., a wireless device named HSPAXRAY2 was detected at 11:55 am) and a geo-location record indicating that patient P was transported to a different treatment site (e.g., the patient P was moved to the surgical suite at 11:59 am). As such, the records provided in Section B provide supplemental information related to the records in Hospital A, Section A.

Hospital PMDF 330p and individual PMDF 530p are related in that the individual PMDF 530p incorporates the hospital PMDF 330p therein. Hospital PMDF 330p, while generated by a hospital for use in the hospital, is a patient record and is therefore incorporated as a record into the individual PMDF 530p as the Hospital A file F101, data file A. As such, Hospital A, file F101 includes data file A which is identical to the hospital patient records and data file B, which includes records related to Hospital A and generated by the individual PMDF 530p.

Access to the hospital PMDF 330p may require proper authorization and/or notification, as required by local, state and federal laws and regulations, before providing access to medical records. As such, hospital PMDF 330p maintains compliance with said laws and regulations. Hospital PMDF 330p may also prevent inadvertent or accidental release of medical records by requiring proper identification and documentation to access the hospital PMDF 330p.

Operation and usage of the PLID 312e and 512a is described further detail below. Upon arrival, the patient P is identified as described above. Utilizing the hospital PLID 312b, an admitting nurse may obtain biometrical information from the patient P and the hospital PLID 312b provides the biometrical information, over the hospital PLID network 200a, to the hospital patient data server 200 (FIG. 2). Patient data server 200, using the biometrical information, positively identifies the patient P by comparing the obtained biometrical information to biometrical information contained in the Identification file F1 in the hospital PMDF 330p. The hospital patient data server 200 identifies the hospital PMDF 330p that corresponds to the patient P and assigns the hospital PMDF 330p to the hospital PLID 312b. The admitting nurse applies the hospital PLID 312b to the patient P and completes the admission process.

In embodiments, patient P may be admitted utilizing the individual PLID 512a. Individual PLID 512a utilizes the geo-location module and determines based on the GPS location that the patient P has arrived at the hospital. Individual PLID 512a transmits a message to the hospital patient data server 200 informing the hospital that patient P is seeking admission. The individual PMDF 530p that corresponds to the patient P is assigned to a hospital PLID 312b and the hospital PLID 312b is used to verify identity when the patient P arrives at the hospital. Alternatively, the individual PLID 512a may connect to the hospital patient data server 200 and provide identical functionality as the hospital PLID 312b. The individual PLID 512a may be temporarily placed in “visitor mode,” thereby temporarily disabling the “request for admission” functionality.

During admission, the hospital PLID 312b may also communicate with the individual PLID 512a and obtain identification information therefrom. Hospital PLID 312b may be used to confirm the identification, as also discussed above. Hospital PLID 312b may also have access to all medication information provided by the individual PLID 512a thereby providing clinicians with a complete medical history of the patient P. After being assigned to the patient P, the hospital PLID 312b continually monitors for the wireless communication devices and equipment and performs the functions described herein. PLID 312b upon receiving an indication that a wireless communication device or equipment is proximate the patient P, PLID 312b opens a record to record the event.

With reference to FIGS. 3 and 4, the identification of hospital personnel function, by the PLID 312b and 512a, is described. The PLID 312b and 512a may interface with a service requester device (hereinafter “SR Device”) to identify hospital personnel that are attending the patient P. SR device is configured to initiate multifunctional conferencing systems, as described in a commonly-owned U.S. patent application Ser. No. 13/768,457, the entire contents of which are incorporated by reference herein. A clinician, e.g., Doctor A, while carrying the SR Device, upon entering the hospital room assigned to the patient P having the hospital PLID 312b, may be automatically identified by the hospital PLID 312b based on its interaction with the SR device worn by the Doctor A. In particular, the hospital PLID 312b, utilizing the wireless communication module therein, identifies that a SR Device is proximate the patient P. Hospital PLID 312b establishes a connection with the SR Device and retrieves identification information and/or data therefrom. Connection to the SR Device may be through a network or a direct peer-to-peer connection.

SR Device may be identified by a specific device name, IP address, device ID MAC address, and any other suitable identifier. Hospital PLID 312b may request identification information directly from the SR Device, the hospital patient data server 200, or any other network that may be utilized to identify the SR Device. Hospital PLID 312b may also request information related to the SR Device and/or the doctor assigned to use the SR Device. SR Device may also be identified by providing the hospital PLID's 312b geo-location information to an SR Device tracking implemented in the applications 201a-201c in the patient data servicer. The SR Device Tracking application provides identification information of the SR Device proximate the PLID 312b. The hospital PLID 312b populates the hospital PMDF 330p with a record that contains information collected about, or provided from, the SR Device and/or the clinician, e.g., Doctor A.

Records in the hospital PMDF 330p may contain a limited amount of information related to the occurrence the generated the record. In embodiments, the record generated by the hospital PLID 312b may indicate that the SR Device assigned to Doctor A was proximate patient P and the record may be filed in the Doctor A file F3 in the hospital PMDF 330p. The hospital PLID 312b and/or the SR Device may also confirm through the hospital PMDF 330p that Doctor A is authorized to access the hospital PMDF 330p of patient P and/or to provide medical care to Patient P.

Identification of equipment may be performed in a similar manner to the identification of hospital personnel as described above. Following the visit by Doctor A, a new radiology record (e.g., prescription) for patient P may be entered into the radiology file F8 of the hospital PMDF 330p. In embodiments, prescription may be an X-ray prescription and the record for the prescription may be entered by Doctor A and/or ordered by Doctor A and entered by a nurse. Regardless of the method of entry, a new record is entered in the radiology file F8 and linked to Doctor A and/or the record of Doctor A entering the room of patient P. Prescription may be any suitable test and/or procedure that a clinician may require.

To complete the X-ray, patient P may be transported to the X-ray machine in a radiology department or a radiology department may transport a portable X-ray machine to the room of the patient P. Hospital PLID 312b may identify the X-ray machine by utilizing an SR device associated with the x-ray equipment and/or the Doctor A and obtain information over a wireless connection. The images obtained by the imaging device of patient P and electronic copies of the images may then be provided to the radiology record in radiology file F8 of the hospital PMDF 330p. Location data and/or information related to the equipment used to obtain the images may also be provided to the radiology record in the radiology file F8 of the hospital PMDF 330p.

In alternative embodiments, the hospital PLID 312b may utilize geo-positioning hardware in the hospital PLID 312b to determine a change in the location of the patient P. The PLID 312b may utilize the geo-positioning data to identify the specific hardware based on the geo-location data for rooms dedicated to a specific function and/or purpose such as imaging rooms (e.g., magnetic resonance imaging (MRI) room, a computed tomography (CT) room, a positron emission tomography (PET) scan room, an X-ray room, an ultrasound rooms, etc.), optometrist examination rooms, a phlebotomist laboratory, a surgical suite, and the like.

Loading information and/or data into the PMDF 330p may generate one or more notifications, such as, loading the electronic copies of the images into the radiology record of the radiology file F8 in the hospital PMDF 330p completes prescription written by Doctor A. A notification that provides the status of the prescription may be generated and then provided to Doctor A. Additionally, radiologists, e.g., Doctors B and C, may receive a request to perform an analysis of the images ordered by Doctor A of patient P. Notifications may be generated by a notification application implemented as one of the applications 201a-201c in the patient data server 200. In embodiments, the notification may be generated by the PLID 212b or generated by any other suitable notification system that has access to the PMDF 330p.

Doctor B, acting on the request to perform an analysis, may then access the radiology record in the PMDF 330p and performs an analysis. The analysis generated by Doctor B is stored as a diagnostic report (e.g., a new record) in the Doctor B file F4 of the hospital PMDF 330p. The diagnostic report generated by Doctor B is linked to the radiology record and/or the prescription ordered by Doctor A. Completion of the diagnostic report may provide an additional updated status notification to Doctor A indicating that the images of patient P have been read by Doctor B indicating that the diagnostic report generated by Doctor B is available for review.

The record system according to the present disclosure provides notification to prevent duplicate work by another clinician, e.g., Doctor C, who also received the request to perform an analysis of the images. Since Doctor B already acted upon the request to perform an analysis, any attempt by Doctor C to duplicate the work performed by Doctor B would notify Doctor C that the work had been performed and would not allow Doctor C to generate a new record in the Doctor C file F5 of the hospital PMDF 330p. This eliminates the possibility that Doctors B and C perform duplicate work.

Doctor A may order a second opinion on the diagnostic report generated by Doctor B. As such, the order for a second opinion would be entered into the hospital PMDF 330p and a request to perform a second opinion is forwarded to Doctor C. Doctor C, acting on the request to perform a second opinion on the diagnostic report, may the access the radiology record and generate an additional diagnostic report. The second opinion generates a new record in the Doctor C file F5 of the PMDF 330p.

Similar to the generation of files for the radiology file F8, records related to pathology are filed in a pathology file F9 and linked to appropriate records in the PMDF 330p. Records related to tests performed in the laboratory are also filed in a laboratory file F10 and linked to the appropriate records in the PMDF 330p. The placement, grouping, linking, and filing of records may be arranged in any suitable manner.

The hospital PLID 312b may also create other records, such as records related to tasks performed by a nurse, which are recorded in a Nursing Record F7; records generated by nursing tasks may include obtaining vital signs (e.g., blood pressure, pulse, oxygen saturation, reflexes, etc.), administering medication, administering fluids (e.g., intravenous therapy or intravenous therapy), checking responsiveness of a patient, recording time and/or amount of bodily fluid release, checking labor progress, or any other task assigned to and/or performed by a nurse. In addition, records in the hospital PMDF 330p may be automatically generated by equipment, generated by the hospital PLID 312b communicating with equipment or manually entered by any clinician.

A hospital PLID 312b may also communicate with equipment and obtain a partial record of information. The clinician may then access the record and provide additional information and/or data not provided by the equipment. For example, a partial record of vital sign information may be automatically generated from information obtained from equipment (e.g., a pulse oximeter). Additional vital sign information (e.g. oxygen saturation levels and temperature) obtained from other equipment may also be entered manually by a clinician into the automatically generated record.

Records related to supplies required by and/or used by the patient P may be recorded in a supplies record F11. Supplies may be equipped with an electronic identifying tag e.g., a radio frequency identification device (RFID tag), barcode or any other suitable identification device. PLID 312b detects that supplies equipped with an electronic identifying tag are provided to the patient P (e.g., within communication range of the PLID 312b) and the PLID 312b generates one or more records in the supply file F11 of the hospital PMDF 330p.

Supplies may also be equipped with a bar code that identifies the supply. Bar codes may provide additional information such as lot number and/or any other manufacturing information. Bar codes may be read by an optical scanner on the PLID 312b or read by a bar code scanner linked to the PLID 312b. Scanning a bar code on the supplies generates a new record containing the bar code information in the supplies folder F11 of the hospital PMDF 330p. Alternatively, the bar code information may be added to an existing record in the PMDF 330p.

The clinician may utilize a bar code scanner to scan a bar code on the on the hospital PLID 312b and to scan a supply bar code. The scan sequence (e.g., scanning the PLID 312b bar code and the supply bar code) generates a new record in the supplies file F11 of the hospital PMDF 330p or adds the supply bar code to an existing record in the PMDF 330p.

As can be appreciated, as the patient P moves through the clinic, hospital, or surgical process, the hospital PLID 312b identifies the patient P, the interactions with clinicians and/or equipment, tests performed on the patient, and notifies clinicians of the test results and other patient P's activities. Additionally, records generated by the hospital PLID 312b may include time-stamps and information may be added to the time-stamped records. Records in the hospital PMDF 330p may also be linked to other related records. As such, linked records may provide a clinician with a list of patients to which they provided services. Linking records may also provide a record of clinicians that accessed a particular record.

The hospital PLID 312b and the records generated and entered into the hospital PMDF 330p provide the status of the patient P thereby improving the efficiency of scheduling through the treatment process. After admission and testing is completed, the clinician may decide to proceed with surgery. The hospital PLID 312b generates a record during each interaction with a clinician, including a record when the patient P travels from surgical admissions to the pre-surgical waiting area. A geo-positioning system on the hospital PLID 312p determines when the patient P has arrived at the pre-surgical waiting area and provides one or more notification to clinicians in pre-surgical waiting area. The hospital PLID 312b also generates a record when doctors performing the surgery conduct their pre-surgical meeting with the patient P. Hospital PLID 312p provides a notification to the surgical staff when all pre-surgical meetings have been conducted, all documents have been signed and provided to the hospital PMDF 330p, and the patient P is cleared for surgery.

Hospital PLID 312b may also push notifications to relevant personnel based on pre-set rules. In embodiments, admission for a surgical procedure may set a rule to provide the surgeons scheduled to perform the procedure with a notification when the patient P is being sedated. Push notifications may also be utilized to inform a cleaning crew when a patient P has left the surgical suite. Notification may be generated when the hospital PLID 312b detects that patient P has left the surgical suite, when the hospital PLID 312b detects that the surgeons are no longer proximate the patient P, and/or when the hospital PLID 312b is proximate a recovery room doctor and/or nurse. Providing the operating suite cleaning crew with notifications informing them that the surgical suite is no longer occupied decreases the amount of time required to turnover the surgical suite after the patient P exits.

The tracking and recording system of the present disclosure also provides for reporting and billing. Tracking the progress and location of the patient P with the hospital PLID 312b improves patient management in that the hospital may evaluate the throughput of patients through the hospital. As illustrated in FIG. 4, the Doctor A report 370a provides a timeline of records created and time-stamped by the hospital PLID 312b and filed in hospital PMDF 330p to expedite the billing. In embodiments, multiple records may be linked, e.g., four records which reflect four interactions between Doctor A and patient P. Hospital protocol may require Doctor A meet with patient P in the pre-surgical waiting area to explain the procedure and to obtain surgical consent (e.g., record A). Additionally, hospital protocol may require Doctor A to meet with patient P after being prepped for surgery and prior to the administration of a general anesthesia (e.g., record B). Record C reflects the interaction between Doctor A and patient P during surgery. Record C may also indicate the duration of the interaction. Records linked to Record C may include nursing records (3 records) and supply records (27 records). Supply records may reflect supplies used during the surgery and/or equipment proximate the patient P during the surgery. Finally, Record D reflects the interaction between Doctor A and patient P in the post-surgical recovery area. Other records connected to the Doctor A report 370a may include billing records from the billing file F11 and insurance records from the insurance file F2 as discussed in detail below. Doctor A report 370a provides a temporal representation of the throughput of patient P though the surgical procedure. Additionally, Doctor A report 370a includes supporting records (e.g., insurance records, nursing records, supply records and billing records) linked to the four doctor records (Records A-D)).

Hospital PLID 312b and hospital PMDF 330p also provide the ability to audit hospital protocols in that a report can be generated to indicate any surgical procedures that proceeded in violation of hospital protocols, e.g., lack of required pre-surgical waiting area meeting and/or lack of pre-anesthesia meeting. In embodiments, hospital PLID 312b may generate a push notification to appropriate hospital personnel indicating a potential violation of hospital protocol. A notification may be generated if patient P departs the pre-surgical waiting area (e.g., enters the surgical prep area) without meeting with Doctor A (e.g., record generated by the hospital PLID 312b) and/or without an electronic copy of a signed consent form being provided to the hospital PMDF 330p (e.g., signed and scanned and/or uploaded as an electronic record).

Notification may also be generated if one of multiple clinicians does not adhere to protocol. Certain surgical procedures may require the coordination of a plurality of doctors to complete the procedure. As such, each doctor may be required to adhere to the hospital protocols such as obtain individual consent forms for their aspect of the procedure. As each doctor meets with the patient P, the hospital PLID 312b identifies the doctor, generates a record of the interaction, and accepts the electronic copy of the signed consent, when entered.

The system 100 according to the present disclosure also allows for analysis of the efficiency of a department using records obtained by the hospital PLID 312b that are stored in the hospital PMDF 330P. As illustrated in FIG. 4, the Radiology Insurance Claim report 370b provides a timeline of records created and time-stamped by the hospital PLID 312b and filed in the hospital PMDF 330p. These records reflect various tasks recorded in the execution of obtaining and reading the X-ray of patient P, in addition to the generation of a bill and an insurance claim for the X-ray. Records include Doctor A ordering the X-ray E, a nurse transporting patient P to radiology F, the taking of the X-ray G, Doctor B analyzing the X-ray H, Doctor C re-examining the X-ray J, the generation of a bill for the X-ray J and the submission of an insurance claim K. Tasks E-J are related to the clinical department and may be used to analyze the efficiency thereof, while task J and K are related to the billing department and may be used to analyze the efficiency thereof.

In analyzing the efficiency of the clinical department, one factor which may be considered is determining the cause of the delay between when Doctor A ordering the X-ray E and actual time of taking of the X-ray G. The delays may be related to many factors, such as, the availability of nursing staff to transfer patient P to the radiology department, availability of equipment and staff to perform the X-ray and many other factors. Obtaining and analyzing similar reports from other patients and departments provide clinicians with the insight required to improve overall system and department efficiencies.

The radiology insurance claim report 370b also provides a timeline for the records, created and time-stamped by the hospital PLID 312b and filed in the hospital PMDF 330p. Billing system utilizes the time-stamped interactions between the patient P and clinicians and/or equipment to generate a bill to reflect the actual services provided. Since multiple services were provided by Doctor A (e.g., examining the patient P and ordering the X-ray), Doctor B (e.g., in providing an initial analysis of the X-ray) and Doctor C (e.g., providing a second opinion as requested by Doctor A), the records for Doctors A-C E, H and J and tasks are all linked to the X-ray service and verification that billing information was appropriately entered and submitted for payment. Appropriate notifications may be pushed to request the submission of accurate billing records when a record has been generated in the hospital PLID 312b without generating a corresponding bill. Further, submission of billing and request for payment from the insurance carrier may also be analyzed for efficiency.

Information generated by the hospital PLID 312b and stored in the hospital PMDF 330p may also be utilized to generate various reports, dashboards, analytics, and matrices to better understand the profitability of a particular department and to help focus resources to improve efficiencies as well as to improve overall clinical outcomes.

Recording the interactions between clinicians and patients P documents the care provided by the clinician. Automatically recording each interaction by utilizing the automatic report generation function of the PLID 312b and a clinician's SR Device ensures that each billable interaction between the clinician and the patient P is documented and recorded by the PLID 312b and filed in the PMDF 330p.

Records generated in the hospital PMDF 330p also provide information related to the frequency of use of equipment to analyze over or under-utilization of resources. For example, a first and second operating suite may each include an electrosurgical generator. Procedures scheduled for the first operating suite typically do not require an electrosurgical generator while procedures scheduled for the second operating suite typically require an electrosurgical generator. The hospital PLID 312b associated with each patient that utilizes a surgical suite communicates with the electrosurgical generator and may only generate a record if the electrosurgical generator is energized. As such, an analysis of hospital PMDF 330p records related to the electrosurgical generators may then demonstrate that one electrosurgical generator is being over-utilized while the second electrosurgical generator is being under-utilized.

Reports may also provide a better understanding of a clinician's daily workflow. A report of a clinician's individual patient interactions provides documentation and/or tracking based on the individual interactions with patients. Reports may also provide a temporal relationship between patient interactions and the geographical relationship between patient interactions.

The system 100 according to the present disclosure may also be used to generate predictive alerts in anticipation of upcoming events. Predictive alerts may be based on operational metrics and/or clinical status. In embodiments, a predictive alert may be generated when a procedure reaches a particular stage (e.g., intubation, incision closure, intubation, wheels-in, wheels-out, etc.). Predictive alerts may assist clinicians and facilities to better assess the timing and needs of incoming patients thereby allowing departments to adjust and/or reassign assets to provide resources to better handle the changing flow of patients.

Reports and predictive alerts may also be utilized to optimize nursing activities based on the priority of tasks due to relocation of patient P and other trigger events. In embodiments, the relocation of patient P may trigger the hospital PLID 312b to generate a record related to the relocation and the report may generate a list of tasks. Various tasks may be generated which include, but are not limited to, completing the paperwork and electronically storing the corresponding data into the hospital PMDF 330p and prepare the vacated area for a new incoming patient P. A predictive alert, based on the status of patient P undergoing a procedure, may then prioritize the preparation of the vacated area as a higher priority task than completing paperwork. The filing of the paperwork for patient P or data entry may still be maintained on the task list and may be completed after the higher priority tasks are complete. Further, outstanding tasks in addition to incomplete tasks may require additional resources to complete in a timely manner. As such, resources may be rebalanced and/or reallocated between departments to better align resources with demands.

Predictive alerts may also include a progress/status bar indicating steps and progress for a given patient P. Progress/status bar may also be provided to the patient P to prove incentives to further progress (e.g., to encourage milestone-generating behavior). Alerts and/or push notifications may be generated based on achieving a particular and defined milestone. In embodiments, notifications may be provided to designated individuals (e.g., family members, friends, or others designated by the patient P) based on milestones, such as, state of anesthesia, duration since close of incision, achieving a physical therapy milestone or any other prognosis indicator.

The system 100 according to the present disclosure may also be used for notifications and patient tracking: In embodiments, alerts and/or push notifications may be broadcast to social networks. A progress and/or status bar may be provided to a social network to inform individuals in the social network informed of the progress and status of the patient P. In turn, support received from the social network may provide additional incentives to further progress (e.g., to encourage milestone-generating behavior).

In further embodiments, hospital PLID 312b may broadcast to a support network (e.g., family) of patient P when patient P enters a hospital setting. Patient P's support may be network at a different geographical location from that of the patient P and may automatically receive a notification that patient P is admitted to a medical facility. Support network may also be notified when a hospital PLID 312b is associated with the patient P. Support network may further be notified when a hospital PLID 312b indicates that patient P has been moved to (or from) a particular location based on geo-location information obtained by the hospital PLID 312b, such as when a nursing home resident is relocated to the hospital portion of a facility, the family members are automatically notified based the change in geo-location information.

Alerts and/or push notifications may be preset within a particular hospital system (similar to emergency contacts) to broadcast under certain scenarios (e.g., hospital admission, ER entrance, etc.). In embodiments, a pediatric hospital that provides medical services to children may configure every hospital PLID 312b and/or the hospital patient data server 200 to automatically generate an alert and/or push notification to parents when the geo-location data changes.

Various patient services may also access the hospital PMDFs 330p, the hospital patient data server 200, and/or the PLID 312b to improve the efficiency of clinicians within a hospital setting. For example, a patient location utility may be incorporated into the hospital patient data server 200 to provide clinicians with geo-location data of all patients linked to a particular clinician. Hospital patient data server 200 may also push notifications to clinicians when a patient linked to that clinician is transferred from one location to another location within the same facility. Notifications may include any suitable message such as, text/SMS messages, voice messages, email messages, pages, etc. Messages may be selected based on the receiver's availability to receive messages, urgency of message, and/or the type of receiving device available to the receiver and any other suitable parameter.

The patient locator utility may also be utilized in an emergency to locate and track the location of patients. In embodiments, in the event of a hospital lockdown, the patient locator utility provides hospital staff and/or emergency personnel with geo-location information for all patients in the facility. The geo-location information may be exported to an emergency tracking system used by emergency personnel to evacuate to a specific location.

The system 100 according to the present disclosure may be also used to track patient care and usage of medical resources: Hospital PLID 312b provides many advantages for the patient P wearing the hospital PLID 312b. The, patient P may access the hospital PMDF 330p containing the records generated by the hospital PLID 312b and obtain information related to the patient care provided to the patient P. In embodiments, patient P may have been unaware of the medical case that was provided due to medication. Patient P may later access the hospital PMDF 330p and display information related to the medical care that was provided. Patient P may also review the name and qualifications of all doctors that provided services based on entries in the hospital PMDF 330p. Patient P may also display information related to medication dispensed, supplies and equipment used and any other information and notes made by clinicians attending to patient P.

Patients with access to their hospital PMDF 330p can view files, records, data and information contained therein. Hospital PMDF 330p provides transparency between patients and caregivers and provides access to information needed to be involved in the clinical/caretaker process.

The system 100 according to the present disclosure may also be used to facilitate provider hand-off. One aspect of the clinical process is the handoff of responsibility from a first clinician to a second clinician. Handoff may occur at multiple levels of care. In embodiments, an outgoing nurse passes responsibility to an incoming nurse and an outgoing doctor passes responsibility to an incoming doctor. Although the patient P may present during the hand-off process, in certain situations, this may not be possible, since multiple hand-offs may be performed simultaneously at different locations, a hand-off may occur when the patient P is unavailable, hand-off may occur when patient P is physically unable to attend, temporarily incapacitated, sedated, and the like.

Existing care provider systems implementing bedside hand-off have been designed to provide accountability of hospital members and patient P involvement. These systems, while proven to improve accountability and encourage patient P involvement, often overwhelm patients and family members with information and are ineffective with respect to patient P involvement when patient P is unavailable or incapacitated.

The hospital PLID 312b and systems described herein according to the present disclosure can be utilized to generate a record of the hand-off for later review by the patient P, their family, and/or care provider of patient P. In embodiments, during the periods of incapacitation, the hospital PLID 312b may be utilized to record the bedside hand-off. Clinicians may also provide supplemental information to the record generated by the hospital PLID 312b and filed in the PMDF 330p. Family members with medical power of attorney over patient P may review the bedside hand-off record by electronically accessing the hospital PMDF 330p through the hospital patient data server 200. Patient P, after recovering from the incapacitation, may later review each of the bedside handoff records to review the medical course and treatment that was provided during the period of incapacitation.

The ability to automate documentation of clinical actions with respect to hand off provides both the patient P and the medical facility with clear and unbiased information related to the care provided to the patient P. Medical services become transparent and patients are provided with a temporal history of events that occur during a time in their life when they are most vulnerable. Additionally, automating documentation of activities within the hospital settings requires clinicians to take ownership of assigned tasks since failure to complete a task in a timely manner is reflected in automatically collected and time-stamped records.

The system 100 according to the present disclosure may be also used for critical care documentation. Hospital PLID 312b may also function as a multi-functional communication and recording device for documenting critical care provided to the patient. In embodiments, under certain conditions the hospital PLID 312b may determine that the condition of patient P is critical and/or life threatening. As such, hospital PLID 312b may continually record audio and/or video in addition to the information discussed above. Additionally, identification portion of hospital PMDF 330p may contain information related to family and/or friend notification in addition to emergency contact information. Hospital patient data server 200 may automatically push notifications based on instructions provided in the identification file F1 of the hospital PMDF 330p. Communication of the clinical status may also be provided and updated as prescribed by the patient P, during a procedure/intervention or clinical Interaction. Hospital PLID 312b may further provide information related to patient P based on predefined rules and/or aspects of the user's behavior. Hospital PLID 312b may include one or more sensors to detect activities of patient P including, but not limited to, circulation, respiration, movement, and combinations thereof.

Once information along with audio/video data is collected, access to a patient's hospital PMDF 330p may be provided to remote user through a remote device through the hospital patient data server 200. Clinical data, electronic documents and any other information and records stored in the hospital PMDF 330p may be shared with a remote user through a remote device.

The system 100 according to the present disclosure may be also used to forecast patient care. Hospital patient data server 200 may include a patient care profile that includes a patient care forecast. Patient care forecast may include, but is not limited to, treatment next steps (e.g., treatment steps defined by the medical team), anticipated medical prognosis (e.g., anticipated recovery and/or warnings of slip-backs), anticipated of side effects; requirements and/or forecast of further testing; indication of risks, forecast of required testing, and combinations thereof.

Patient care forecast may also generate alerts and/or push notifications to inform clinicians and family members of upcoming events. Forecasts and subsequent alerts may provide an opportunity to consolidate testing. In embodiments, forecasting that a blood draw is required to test medication levels may prompt the consolidation of other blood-related testing thereby preventing multiple blood-draws and improving patient comfort.

Patient care forecast may be also used to predict an intended care path (e.g., anticipated and/or planned care path) that includes follow-up medications, evaluations, and follow-up visits. The intended care path may be discussed with patient P prior to a procedure and one or more aspects of the intended care path may be implemented prior to the procedure. In embodiments, patient P and clinician may discuss an intended care path for a particular surgical procedure and clinician and patient P may agree on medications to be prescribed after the surgical procedure, follow-up care procedures and schedule the post-surgical follow-up appointment prior to the procedure. Modifications to the intended care path may be made during the course of the surgical procedure. Patient P can view the intended care path to understand the actions being taken and their progress in the continuum of clinical care.

Patient care forecast may also include any steps required prior to the procedure. Steps may include, but not limited to, providing documentation necessary to go forward with the procedure, instructions related to eating/drinking prior to the procedure, expectations before, during, and after the procedure, validation of insurance information, validation of clinical contact information, validation of payment information, and combinations thereof.

The system 100 according to the present disclosure may be also used in consumption tracking based on the reports generated from data collected by the hospital PLID 312b. Reports related to the tracking of supplies and equipment by the hospital PLID 312b and reports related to the consumption and use of materials in the hospital PMDF 330p provide tools to forecast consumption, track material shrinkage and reduce the non-value added time of gathering and/or searching for supplies, locating items, and the like. Additionally, equipment failure and/or symptoms of potential equipment failures may be parsed from data recorded in the hospital PMDF 330p and provided to equipment representatives or used to generate a subsequent maintenance work-order. Material detected and identified as one-time use materials may trigger a report to determine if use of the materials is reported in another hospital PMDF 330p.

In embodiments, a sterile table may be stocked with a number of one-time use items. The sterile table may be equipped with an RFID (e.g., RFID individually identifies each item on the table) or the individual items on the surgical table may have an individual RFID tag. When patient P is transported into the surgical suite the RFID information is recorded in the supplies file F11 of the hospital PMDF 330p associated with patient P. The RFID obtained by the hospital PLID 312b may be checked against the supply file F11 of all other patients to confirm that the single-use items detected by the hospital PLID 312b have not be entered into a supply file F11 of another patient (e.g., used by another patient during another surgical procedure). Identification of a reused product may indicate that the sterile table is compromised with products that have been used during another surgical procedure. An alert and/or push notification may be provided to appropriate clinicians to prevent the use of the reused items and to ensure that the surgical suite is cleaned.

The system 100 according to the present disclosure may also be used for medication tracking. In particular, the hospital PLID 312b and records in the hospital PMDF 330p may be utilized to track medications. The entry of a prescription into the hospital PMDF 330p may trigger the hospital patient data server 200 to perform a medication safety check to ensure that the medication may be administered to the patient P. Medication safety check may determine if patient P is allergic to the specific medication thereby generating an alert that the mediation should not be administered. Mediation safety check may also determine if the prescribed medication is a member of a family of medications and determine the probability that patient P may be allergic to the prescribed medication. Medication safety check may push a warning to the patient care forecast that warns of the potential allergen and provides signs that the patient P is showing signs of an allergic reaction to the medication. Medication safety check may also push a list of potential side effects of the medication to the patient care forecast. Each potential side effect may include the timeframe when the side effect is likely to be observed.

Hospital PLID 312b and hospital PMDF 330p may also be utilized to generate a location map of medications that are being administered to patients. Location map of medications may be utilized to prevent exposure a patient allergic to medications from being exposed to a particular medication. Location tagging of medications being prescribed to each patient allows clinicians to segregate patients with a history of severe allergic reaction to drugs. In embodiments, a patient that has experienced Stevens-Johnson Syndrome (SJS) from a particular medication (or medications) may be isolated from patients receiving that medication or any similar and/or related medication.

The system 100 according to the present disclosure may also be used for timeline reporting. Patient P may generate a timeline reports from records, information and data contained in files of the individual PMDF 530p. With reference to FIG. 6, Time Selection 1 Report 570c includes all records, information and data contained in the individual PMDF 530p with a time-stamp between May 21st and May 26th. The Time Selection 1 Report 570c provides the patient P with a timeline of records, information and data from all sources thereby allowing patient P to review the medical related services provided during this timeframe. Patient P may select one or more of the timeline entries to review the individual details contained therein. Time Selection 2 Report 570d provides a detailed view of a portion of the Time Selection 1 Report 570c. Time Selection 2 Report 570d includes reports, information and/or data contained in the individual PMDF 530p with a time-stamp between 1:30 pm and 6:30 pm on May 25.

Selecting an individual record, information and/or data entry provides the patient P with the content of the record and links to other records contained in the individual PMDF 530p. In embodiments, selecting a particular test provides patient P with the clinician that ordered the test, the information obtained by the test, and any analysis of the test results (e.g., notes and comments from the clinician that read/diagnosed the test). Additionally, the record may include a list of clinicians that were notified that the test was performed (e.g., listing of push notifications generated by the completion of the test). Push notification may also provide the status of the notification (e.g., not read, read, read and responded). Records may further include a list of clinicians that accessed the record to examine the results of the test.

The system 100 according to the present disclosure may also be used to manage medication administration. Individual PLID 512a may assist the patient P in tracking and/or administration of medications. In embodiments, individual PLID 512a may include a medication notification and tracking feature that interfaces with the information stored in the individual PMDF 530p. Prescribed medications are listed in addition to the order status. Individual PLID 512a provides instructions as to the timing and process for administering prescribed medications and records as well as any changes or variations to the administration of medications. Medication tracking feature allows the patient P to verify that medications have been administered thereby preventing patients with memory issues from taking multiple doses of medication.

Individual PLID 512a may also interface with an automated medication dispensing system. Individual PLID 512a provides the automated medication dispensing system with a medication schedule, and automated medication dispensing system dispenses medication according to this schedule. Alternatively, the individual PLID 512a provides patient P with a notification that medications must be administered. The individual PLID 512a triggers the automated medication dispensing system to dispense medication according to a medication schedule. Medication schedule may reside in a file of the individual PMDF 530p where clinicians, care providers and family members providing care to the patient P can monitor and/or change the medication schedule.

The individual PLID 512a and an identification system (e.g., barcode, RFID tagging, or other tagging method) may be utilized to track medication. In embodiments, patient P can utilize the individual PLID 512a imaging module (e.g., camera and/or scanner) to identify a container of medication and the individual PLID 512a then provides instructions to the patient P in accordance with the medication schedule.

Individual PLID 512a may also be utilized to restock an automated mediation dispensing system. Individual PLID 512a may be used to identify a container of medication and may provide an unlock code to access a restocking chamber in the automated medication . . . dispensing system.

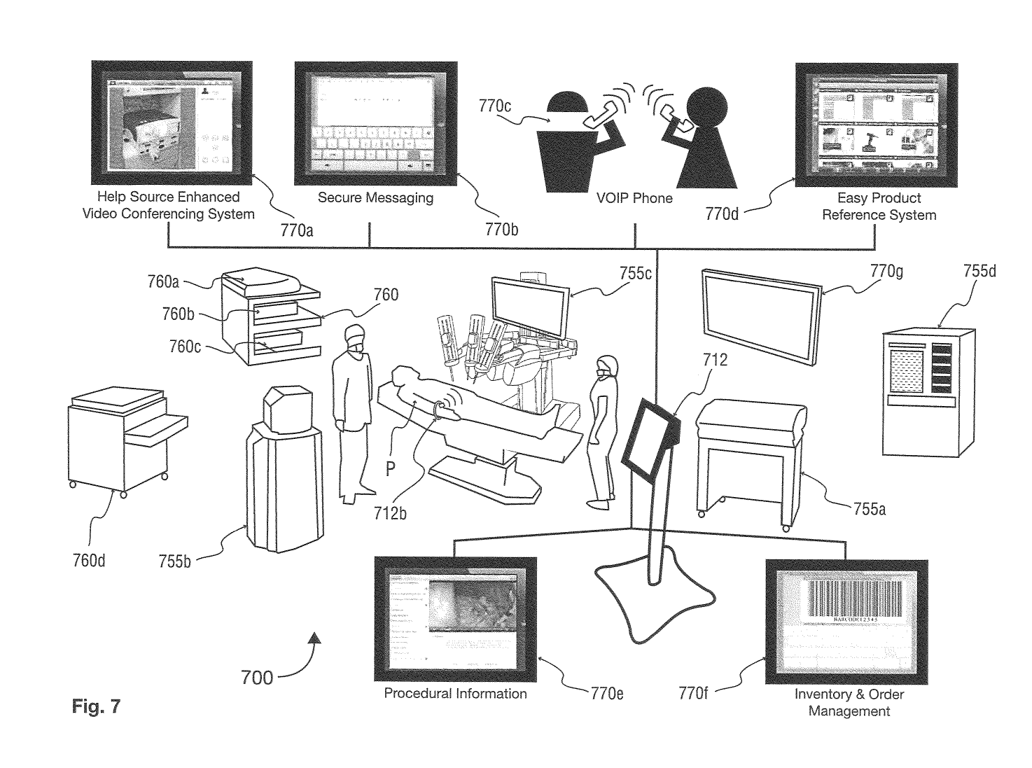

FIG. 7 illustrates a surgical suite 700 utilizing a surgical kiosk 712 for use during a surgical procedure. Surgical kiosk 712 may be a stand-alone system configured to perform any of the tasks and embodiments described herein. In embodiments, surgical kiosk 712 may be configured to interface with a PLID 712b, which is substantially similar to the PLID 212a-212e, associated with a patient P in accordance with embodiments of the present disclosure. Surgical suite 700 may include equipment as defined and described herein, such as an electrosurgical generator 755a, imaging system 755b, robotic surgical system 755c and a remote surgical station 755d, and the like. Surgical suite 700 also includes one or more supply stations 760 and 760d storing supplies having an associated barcode, RFID or any other suitable identification device. Supply station 760 includes supply shelves 760a-760c, which are positioned adjacent the patient P. The supply cabinet 760d may be position away from the patient P. The distance between the supply cabinet 760d and the surgical kiosk 712 may be selected to prevent the surgical kiosk 712 from detecting the RFID's of supplies contained within the supply cabinet 760d.

Surgical Kiosk 712 is a multi-functional device that may include one or more of the functional components included in the multifunctional PLID 212a-212e described above. In addition to the functional components described above, surgical kiosk 712 may include one or more components, modules or applications configured to provide enhanced video conferencing 770a, secure messaging 770b, a voice over IP 770c, product referencing 770d, procedural information 770e and/or inventory and order management 770f.

Surgical kiosk 712 may connect to, and/or interface with, a hospital PLID 312b and an associated PMDF 330p and/or an individual PLID 512a and an associated individual PMDF 530p, as described herein.

Surgical kiosk 712 may be configured to perform the functions of the PLID 312b, 512a while the patient P is in the surgical suite 700 or any portion thereof. In embodiments, surgical kiosk 712 may connect to the PLID 312b, 512a, 712b over a wireless communication network and may temporarily function as the PLID 312b, 512a, 712b of the patient P. As such, surgical kiosk 712 may be associated with the PMDF 330p, 530p of the patient P and may generate records and provide data and information as described herein with respect to the PLID 312b, 512a, 712b.

Surgical kiosk 712 may also interface with one or more remote monitoring stations 770g. Images, video and applications displayed on the surgical kiosk 712 may be provided to a remote monitoring station 770g to allow all clinicians in the surgical suite 700 to view the various functions, displays and modules.

Surgical kiosk 712 may provides hands-free functionality within the surgical suite 700. Surgical kiosk 712 may respond to voice commands, verbal communication, body gestures and/or equipment use. Surgical kiosk 712 may also be configured to recognize various sounds generated within the surgical suite 700.

Clinicians may activate a voice recognition module of the surgical kiosk 712 and may issue specific verbal commands thereto. In embodiments, a clinician may open a new record by verbalizing the phrase “generate record” and the new record may be populated by scanning a barcode of a particular supply and/or providing a narrative of a particular task. In further embodiments, clinician may generate an antibiotic prophylaxis record R1 by verbalizing, “generate record” and then scanning a barcode on the specific antibiotic medication administered to the patient P.

Surgical kiosk 712 may also be configured to generate records by recognizing specific words commonly used during a surgical procedure. In embodiments, a surgeon may request an instrument (e.g., scalpel) and surgical kiosk 712 may associate the audible request for a scalpel with the task of generating an incision in the patient P. In further embodiments, a request for a “sponge” may be associated with blood loss and may generate a blood loss record R6. Other terms that may be recognized may include, but are not limited to, “glove change” to generate a glove change record R7 or any other suitable command or request that may be associated with a step and/or milestone during a surgical procedure.

Clinicians may also interface with the surgical kiosk 712 by presenting a body gesture to the optical sensor on the front or back of the surgical kiosk 712. Use of body gestures provides a clinician the ability to interface with the surgical kiosk without physically touching the device thereby preventing contamination of the surgical site. A record may be opened by reaching for a device, supply and/or equipment. In embodiments, clinician may reach for the electrosurgical generator 755a and the body gesture (e.g., reaching for the electrosurgical generator 755a) generates an equipment record. Hand gestures may also include a series of movements that result in opening a particular type of record.

Use of equipment 755a-755d also exchanges usage in formation between the equipment and the surgical kiosk 712. Information may be used to generate an equipment record or other medical related record. In embodiments, a fluid metering station may provide information related to fluids delivered to a patient P during a surgical procedure and the surgical kiosk 712 may generate a hydration record R2 or hydration rate record R9. Similarly, performance of an air test of equipment and a subsequent correction and/or fix of the equipment may result in a record related to the air test and appropriate fix record R4.

Surgical kiosk 712 may also generate a record based on various sounds generated in the surgical suite 700. In embodiments, alarms and/or indicators from equipment 755a-755d may automatically generate a record related to the alarm and/or indicator of the equipment 755a-755d.

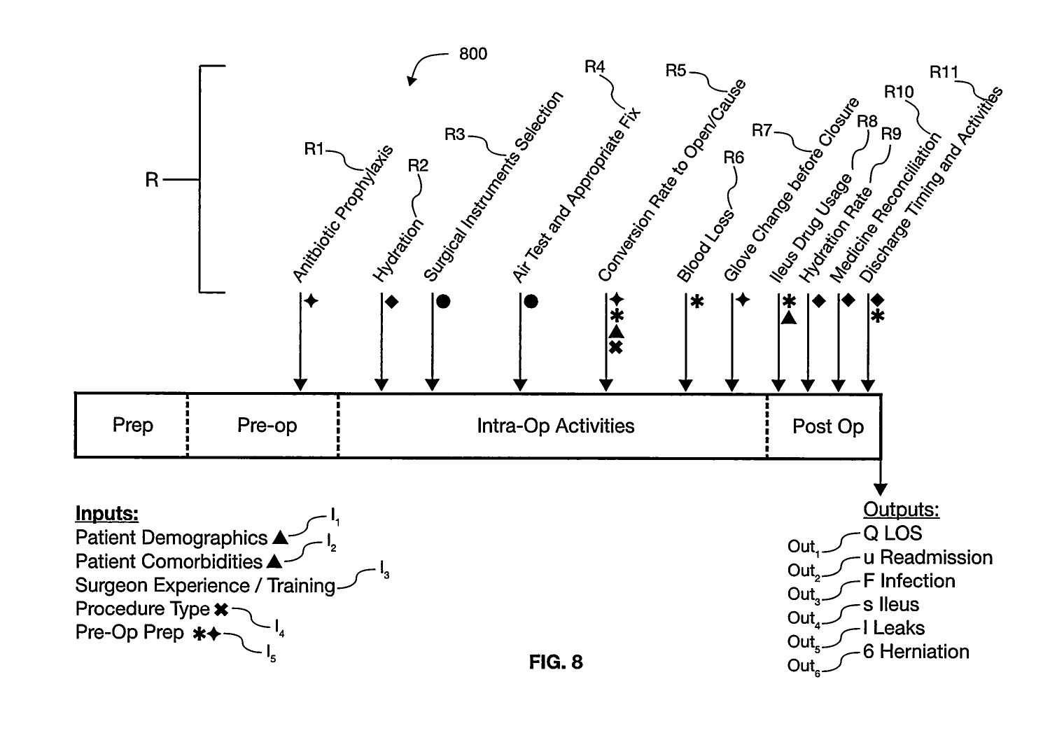

FIG. 8 shows a surgical timeline 800 of events recorded by the surgical kiosk 712, by the hospital and/or individual PLID 312b, 512a, as records R1-R11 that occur during a surgical procedure. Events and/or records may be automatically generated, manually generated or generated by utilizing one or more features and/or functions of the surgical kiosk 712 or PLID 312b, 512a, 712b. It is understood that any function performed by the surgical kiosk 712 may be similarly performed by the PLID 312b, 512a, 712b and vice-versa.

Other records R1-R11 may be automatically generated and/or manually entered by a clinician to obtain various milestones during each surgical procedure. Other records may include, but are not limited to, inputs related to the particular procedure, patient demographics I1, patient commodities I2 (e.g., coexisting medical conditions or disease processes that may or may not be related to the medical diagnosis), surgeon experience/training I3, procedure type I4 pre-operation preparation, and the like and prep I5, outputs from the particular surgical procedure, such as length of stay (LOS) Out₁, Readmission Out₂, Infection Out₃, occurrence of obstructions such as an ileus Out₄, occurrence of leaks Out₅ and/or occurrence of herniation Out₆, and the like.

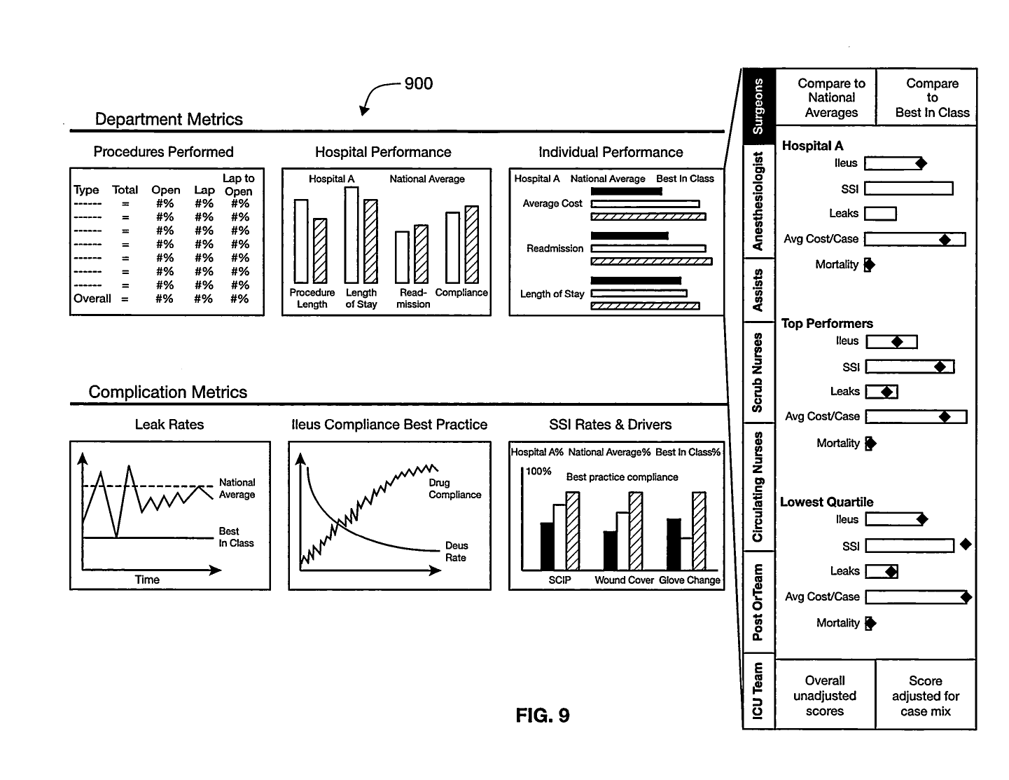

FIG. 9 shows a report generation system 900 for use with data obtained and generated from the system, devices and methods of the present disclosure. Surgical kiosk 712 and the various types of PLID 212a-212e, 312b, 512a, 712b generate records for the PMDF's 330p, 530p. The report generation system 900 provides performance measures for internal comparison and comparison between other facilities. Systems, methods and devices described herein provide consistent data collection between procedures and facilities thereby providing meaningful comparisons.

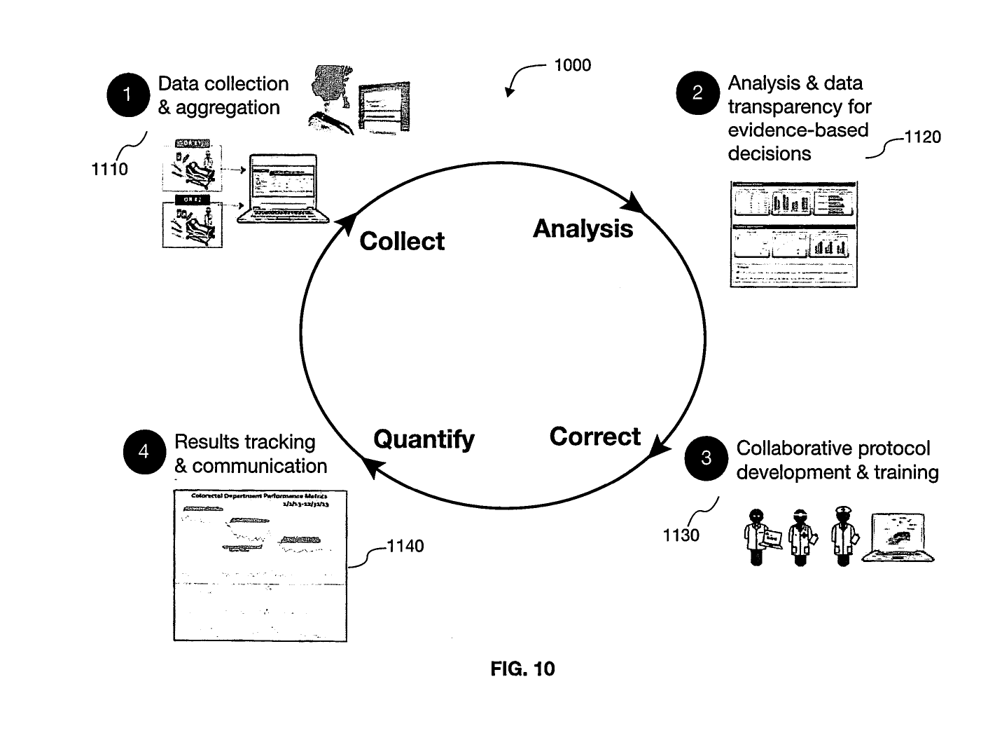

FIG. 10 is a flow diagram illustrating the use of data generated by the systems 1000, devices and methods for improving the efficiency of medical care of the present disclosure. Devices and systems described herein provide consistent and/or standardized collection of data as seen in step 1110. Report generation system 900 provides the ability to perform analysis as seen in step 1120. Consistent generation of records containing data and information provides transparency between surgical suites between facilities, thereby permitting evidence-based decisions to be made with respect to procedures and methods of performing surgical tasks. Information obtained from a plurality of facilities also allows the generation of collaborative protocols for particular surgical procedures and allows for the standardization of testing, development, and/or training of personnel as represented by step 1130. Further, improvements obtained from the changes may be quantified, tracked and/or communicated to the various facilities as represented by step 1140.

The described embodiments of the present disclosure are intended to be illustrative rather than restrictive, and are not intended to represent every embodiment of the present disclosure. Further variations of the above-disclosed embodiments and other features and functions, or alternatives thereof, may be made or desirably combined into many other different systems or applications without departing from the spirit or scope of the disclosure as set forth in the following claims both literally and in equivalents recognized in law.

What is claimed is:

1. A system for tracking the location and activities of a patient, the system comprising:
a patient location identification device associated with a patient;
a patient data server including at least one server application executable on a computer, the patient data server remotely located from the patient location identification device wherein the patient data server and patient location identification device are configured to dynamically communicate with each other through the at least one server application; and
a patient medical data file residing in at least one of the patient location identification device or the patient data server, the patient medical data file configured to maintain a plurality of recordable events generated by the patient location identification device.

2. The system according to claim 1, wherein the patient location identification device includes a geo-location module configured to provide a geo-location of the patient and map data.

3. The system according to claim 2, wherein the patient location identification device is configured to provide navigational guidance to the patient based on the geo-location of the patient and the map data.

4. The system according to claim 2, wherein the patient location identification device is configured to generate an alert based on the geo-location of the patient, the map data and a patient status.

5. The system according to claim 2, wherein the patient location identification device is configured to generate a recordable event related to a change in the geo-location of the patient and the recordable event is stored as a geo-location record in the patient medical data file.

6. The system according to claim 1, wherein the patient location identification device is configured to generate a recordable event related to a medical examination by a clinician and the recordable event is stored as a medical examination record in the patient medical data file.

7. The system according to claim 6, wherein the patient location identification device is configured to generate an audio recording of the medical examination and the audio recording is stored as part of the medical examination record in the patient medical data file.

8. The system according to claim 1, wherein the patient location identification device is configured to generate a recordable event related to an electronic communication with a medical device and the recordable event is stored as a device record in the patient medical data file.

9. The system according to claim 8, wherein the medical device provides identification information corresponding to a clinician associated with the medical device and the patient location identification device generates a recordable event stored as a clinician record in the patient medical data file based on the identification information.

10. The system according to claim 9, wherein the medical device generates operational data related to the operation of the medical device and the operation data is stored in the device record in the patient medical data file.

11. The system according to claim 1, wherein the patient location identification device is configured to generate a recordable event related to a sensing of a radio frequency identification device (RFID) and the recordable event is stored as an RFID record in the patient medical data file.

12. The system according to claim 1, wherein the patient location identification device is configured to generate a recordable event related to medical data provided to the patient location identification device by a clinician and the recordable event is stored as a medical data record in the patient medical data file.

13. The system according to claim 1, wherein the patient location identification device is configured to generate a notification based on at least one record stored in the patient medical data file.

14. The system according to claim 13, wherein the notification is selected from the group consisting of a text message, a voice message, an email message, a page, a blog posting, a web page, and combinations thereof.

15. A non-transitory computer-readable medium comprising software for monitoring patient location, which software, when executed by a computer system, causes the computer system to perform operations comprising a method of:
receiving information related to surrounding environment of a patient;
categorizing the information; and
generating and storing a medical record related to the information.

16. The medium as set forth in claim 15, wherein the receiving step further comprises:
receiving geo-location data related to a location of the patient; and
determining whether the received geo-location data is medically related.

17. The medium as set forth in claim 15, wherein the receiving step further comprises:
receiving medical device identification information via a wireless communication network from a medical device; and
receiving information and/or data related to the patient from the medical device.

18. The medium as set forth in claim 15, wherein the receiving step further comprises:
detecting an RFID associated with a single-use product;
obtaining identification information from the RFID that uniquely identifies the single-use product; and
determining a prior-use of the single-use product.

19. The medium as set forth in claim 15, wherein the receiving step further comprises:
receiving user-entered medical information pertaining to the patient;
associating the received user-entered medical information with a clinician; and
updating the medical record based on the received user-entered medical information.

20. The medium as set forth in claim 15, wherein the receiving step further comprises:
detecting a service requester device associated with a clinician;
receiving identification information corresponding to the clinician from the service requester device; and
updating the medical record based on the identification information corresponding to the clinician.
